(19) United States
(12) Patent Application Publication
(10) Pub. No.: US 2021/0336738 A1
(43) Pub. Date: Oct. 28, 2021

(54) COMMUNICATION DEVICE AND COMMUNICATION METHOD

(71) Applicant: Panasonic Intellectual Property Corporation of America, Tarrance, CA (US)

(72) Inventors: Takayuki NAKANO, Ishikawa (JP); Yoshio URABE, Nara (JP); Takashi IWAI, Ishikawa (JP); Tomofumi TAKATA, Ishikawa (JP)

(21) Appl. No.: 17/284,385

(22) PCT Filed: Oct. 3, 2019
(86) PCT No.: PCT/JP2019/039047

§ 371 Date: Apr. 9, 2021

(30) Foreign Application Priority Data
Oct. 26, 2018 (JP) 2018-202052

(51) Int. Cl. H04L 5/00; H04W 72/04; H04W 74/08

(52) U.S. Cl. CPC H04L 5/0048; H04W 74/0833; H04W 72/0453

(57) ABSTRACT

An AP (100) with which a Midamble can be set appropriately. For a plurality of user-multiplexed terminals a Midamble configuration determination unit (109) in the AP (100) determines, for each of the plurality of terminals, a configuration of a reference signal inserted into a data field. A wireless transmission/reception unit (104) carries out a communication process on a user-multiplexed signal on the basis of the configuration of the reference signal.

### TECHNICAL FIELD

The present disclosure relates to a communication apparatus and a communication method.

### BACKGROUND ART

In IEEE (the Institute of Electrical and Electronics Engineers) 802.11ax, Midambles have been introduced in order to improve performance in fast speed fading environments (see, for example, Non-Patent Literature (hereinafter, referred to as “NPL”) 1). For example, a Midamble has the same configuration as an HE-LTF (High Efficiency Long Training Field) of a Preamble, and is used to improve the channel estimation accuracy.

### CITATION LIST

### Non-Patent Literature

NPL 1
IEEE 802.11-17/0994r0 “Midamble Design”

NPL 2
IEEE 802.11-15/0349r2 “HE-LTF Proposal”

NPL 3
IEEE 802.11axTM/D3.0

### SUMMARY OF INVENTION

However, a method for configuring Midambles has not been fully studied.

One non-limiting and exemplary embodiment facilitates providing a communication apparatus and a communication method that can properly configure Midambles.

In an embodiment, the techniques disclosed here feature a communication apparatus including: control circuitry which, in operation, determines, for each of a plurality of terminals to be user-multiplexed, a configuration of a reference signal to be inserted into a data field for the plurality of terminals; and communication circuitry which, in operation, performs communication processing of signals to be user-multiplexed based on the configurations of the reference signals.

In an embodiment, the techniques disclosed here feature a communication method including: determining, for each of a plurality of terminals to be user-multiplexed, a configuration of a reference signal to be inserted into a data field for the plurality of terminals; and performing communication processing of signals to be user-multiplexed based on the configurations of the reference signals.

It should be noted that general or specific embodiments may be implemented as a system, a method, an integrated circuit, a computer program, a storage medium, or any selective combination thereof.

According to an embodiment of the present disclosure, it is possible to appropriately configure Midambles.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an exemplary configuration of Midambles;

FIG. 2 is a diagram illustrating an example of a correspondence between a sum of the number of space-time streams and the number of HE-LTF symbols;

FIG. 3 is a diagram illustrating an exemplary configuration of the number of HE-LTF symbols;

FIG. 4 is a diagram illustrating exemplary configurations of information bits and Padding bits;

FIG. 5 is a diagram illustrating exemplary configurations of Midambles for terminals having different speeds;

FIG. 6 is a block diagram illustrating an exemplary configuration of a part of an AP according to Embodiment 1;

FIG. 7 is a block diagram illustrating an exemplary configuration of the AP for down link multi-user multiplexing according to Embodiment 1;

FIG. 8 is a block diagram illustrating an exemplary configuration of a terminal for down link multi-user multiplexing according to Embodiment 1;

FIG. 9 is a sequence diagram illustrating exemplary operations of the AP and the terminal for downlink multi-user multiplexing according to Embodiment 1;

FIG. 10 is a diagram illustrating an exemplary configuration of a preamble and data according to Embodiment 1;

FIG. 11 is a diagram illustrating an exemplary configuration of the number of HE-LTF symbols according to Embodiment 1;

FIG. 12 is a diagram illustrating exemplary configurations of Midamble configurations in a V2X environment according to Embodiment 1;

FIG. 13 is a diagram illustrating examples of Midamble configurations configured in respective terminals according to Embodiment 1;

FIG. 14 is a block diagram illustrating an exemplary configuration of a terminal for uplink multi-user multiplexing according to Embodiment 1;

FIG. 15 is a block diagram illustrating an exemplary configuration of an AP for uplink multi-user multiplexing according to Embodiment 1;

FIG. 16 is a sequence diagram illustrating exemplary operations of the AP and the terminal for multi-user multiplexing according to Embodiment 1;

FIG. 17 is a diagram illustrating an exemplary configuration of a Trigger frame according to Embodiment 1;

FIG. 18 is a diagram illustrating exemplary configurations of preambles and data according to Embodiment 1;

FIG. 19 is a block diagram illustrating an exemplary configuration of an AP according to Embodiment 2;

FIG. 20 is a block diagram illustrating an exemplary configuration of a terminal according to Embodiment 2;

FIG. 21 is a diagram illustrating examples of Midamble configurations according to Embodiment 2;

FIG. 22 is a block diagram illustrating an exemplary configuration of an AP according to Embodiment 3;

FIG. 23 is a block diagram illustrating an exemplary configuration of a terminal according to Embodiment 3;

FIG. 24 is a diagram illustrating an exemplary configuration of a Trigger frame according to Embodiment 3;

FIG. 25 is a diagram illustrating a relationship between an RA-AID and an RU according to Embodiment 3;

FIG. 26 is a diagram illustrating exemplary definitions of Midamble configurations according to Embodiment 4;

FIG. 27 is a diagram illustrating exemplary definitions of Midamble configurations according to Embodiment 4;

FIG. 28 is a diagram illustrating exemplary definitions of Midamble configurations according to Embodiment 4;

FIG. 29 is a diagram illustrating exemplary definitions of Midamble configurations according to Embodiment 4; and

FIG. 30 is a diagram illustrating exemplary definitions of Midamble configurations according to Embodiment 4.

### DESCRIPTION OF EMBODIMENTS

Embodiments of the present disclosure will be described in detail below by referring to the drawings. It should be noted that in the embodiments, the same component is denoted by the same reference numeral, and description thereof will be omitted because it is duplicated.

[Configuration of Number of HE-LTF Symbols in Midamble]

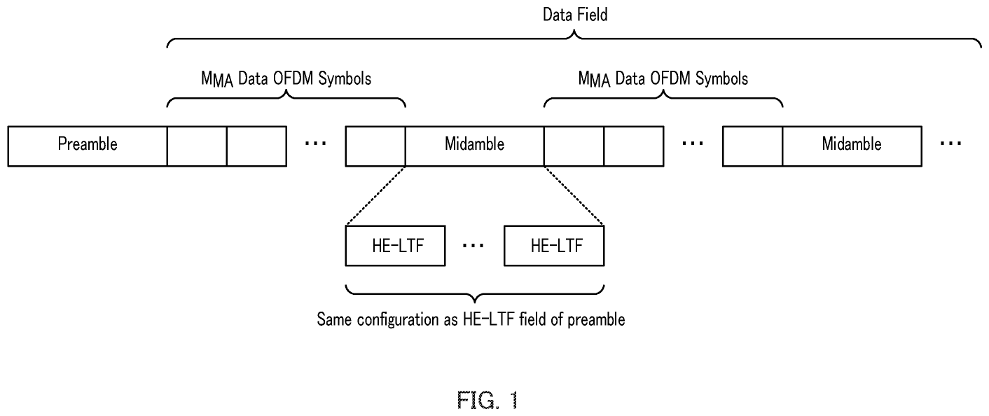

For example, as illustrated in FIG. 1, in a data field following a Preamble, a Midamble is inserted every M_{MA} data symbols (OFDM (Orthogonal Frequency Division Multiplexing) symbols).

The number of HE-LTF symbols (e.g., corresponding to reference signals or pilot signals) in each Midamble is determined, for example, corresponding to a sum of the number of space-time streams of each terminal (also referred to as “STA (Station)” or “UE (User Equipment)”). In addition, a configuration of the number of HE-LTF symbols in a Midamble is common to all the resource units (RUs) in OFDMA (Orthogonal Frequency Division Multiple Access) multiplexing.

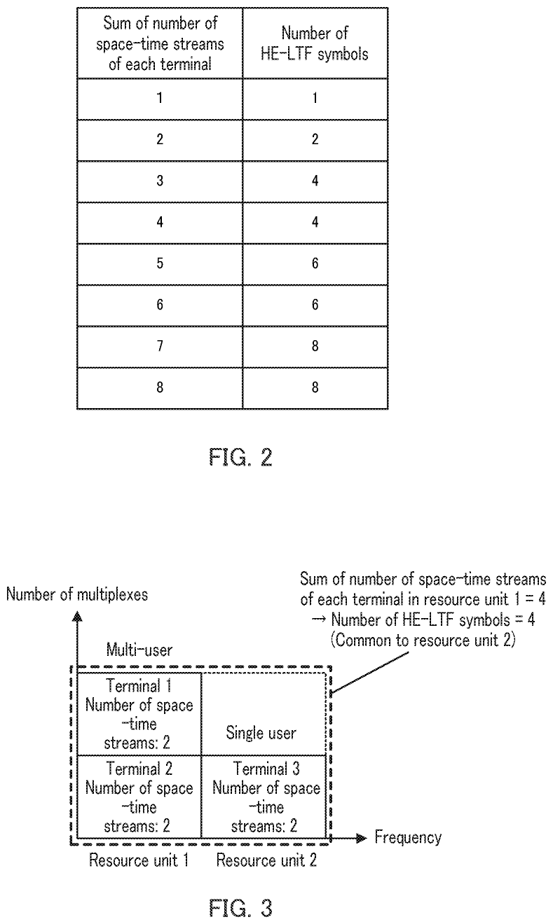

FIG. 2 illustrates an example of a correspondence between a sum of the number of space-time streams and the number of HE-LTF symbols. FIG. 3 illustrates an exemplary configuration of the number of HE-LTF symbols when a multi-user multiplexed resource unit (in other words, a resource unit to which a plurality of terminals are allocated) and a single-user resource unit (in other words, a resource unit to which a single terminal is allocated) are mixed.

It should be noted that here, the term “multi-user” is defined as a generic term including MU-MIMO (Multi User-Multiple Input Multiple Output) and OFDMA.

As illustrated in FIG. 3, a user multiplexing status differs depending on the resource unit, and a sum of the number of space-time streams of each terminal differs depending on the resource unit. In this case, based on the maximum of the sums of the number of space-time streams in the respective resource units, for example, referring to the correspondence in FIG. 2, the common number of HE-LTF symbols is set to all the OFDMA multiplexed resource units.

In the example of FIG. 3, in the resource unit 1, it is the multi-user that has the number of multiplexes of 2, and the number of space-time streams of each of the two terminals (for example, the terminal 1 and the terminal 2) is 2. Thus, the sum of the number of space-time streams in the resource unit 1 is 4. On the other hand, in the resource unit 2, it is the single user that has the number of multiplesexs of 1, and the number of space-time streams of the single terminal is 2. Thus, the sum of the number of space-time streams in the resource unit 2 is 2.

In the example of FIG. 3, of all the resource units 1 and 2, the resource unit 1 has the maximum of the sums of number of space-time streams. Accordingly, in FIG. 3, the number of HE-LTF symbols is set to “4” based on the sum of the number of space-time streams of the resource unit 1 “4” and according to FIG. 2. The configuration of the number of HE-LTF symbols “4” is common to all the OFDMA multiplexed resource units including the resource unit 2, in addition to the resource unit 1.

In this way, the overhead increases because the common number of HE-LTF symbols is set to all the resource units even when the sum of the number of space-time streams for each resource unit differs. For example, in the example of FIG. 3, in one resource unit of the resource unit 2, the number of space-time streams is 2 and the corresponding number of HE-LTF symbols (see, for example, FIG. 2) is 2, whereas the number of HE-LTF symbols for the resource unit 2 is set to 4. In other words, in the example of FIG. 3, an unnecessary Midamble is inserted into the resource unit 2, and the overhead increases. In particular, the more the sum of the number of space-time streams is, the more the number of HE-LTF symbols is (see, for example, FIG. 2), and thus, the more significant the increase in the overhead is.

[HE-LTF Mode in Midamble]

Similar to a Preamble, an HE-LTF mode (e.g., 1×/2×/4×HE-LTF) having a different time interval is provided in an HE-LTF within a Midamble (see, for example, NPL 2). These HE-LTF modes have the following characteristics, and are assumed to be selectively used depending on usage environments.

1×HE-LTF: Mode that maximizes the peak throughput in an indoor (e.g., multipath delay: small) environment. In 1×HE-LTF, the HE-LTF overhead is minimized among the HE-LTF modes.

4×HE-LTF: Mode that maximizes the performance in an outdoor (e.g., multipath delay: large) environment. However, in 4×HE-LTF, the HE-LTF is larger.

2×HE-LTF: Mode that takes into account the trade-off between the performance and the overhead in various environments such as indoors, outdoors, or the like, for example.

The common HE-LTF mode in the Midamble is configured in all the OFDMA multiplexed resource units, similar to the number of HE-LTF symbols.

[Signaling of Midamble Configuration]

A common Midamble configuration including the presence or absence or a periodicity of a Midamble is configured in all the multi-user multiplexed terminals.

For example, for a Midamble configuration, the presence or absence (e.g., Doppler subfield) and a periodicity (e.g., M_{MA}=10 or 20 [symbols]) of a Midamble are signaling from an access point (also referred to as “AP” or “base station”) to terminals using a control signal common to the terminals. It should be noted that the control signal (or control field) common to the terminals include, for example, an HE-SIG-A, a common information field (Common Info field) of a Trigger frame, or the like.

In multi-user multiplexing, padding bits are added to information bits of the other terminals in line with the maximum number of information bits among the numbers of information bits of the terminals to be user-multiplexed so that the numbers of OFDM symbols of the terminals to be multiplexed are the same among the terminals. Calculation of the padding bits to be added may, for example, be in accordance with Equations (28-60) to (28-65) and Equations (28-75) to (28-90) of IEEE 802. 11ax standard (see, for example, NPL 3), or may be in accordance with other calculation methods.

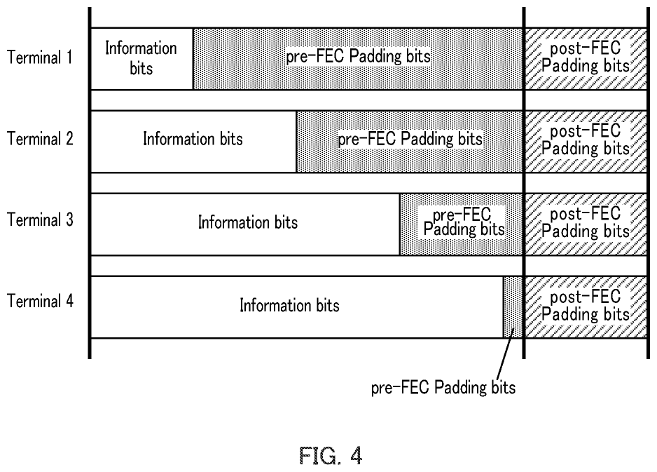

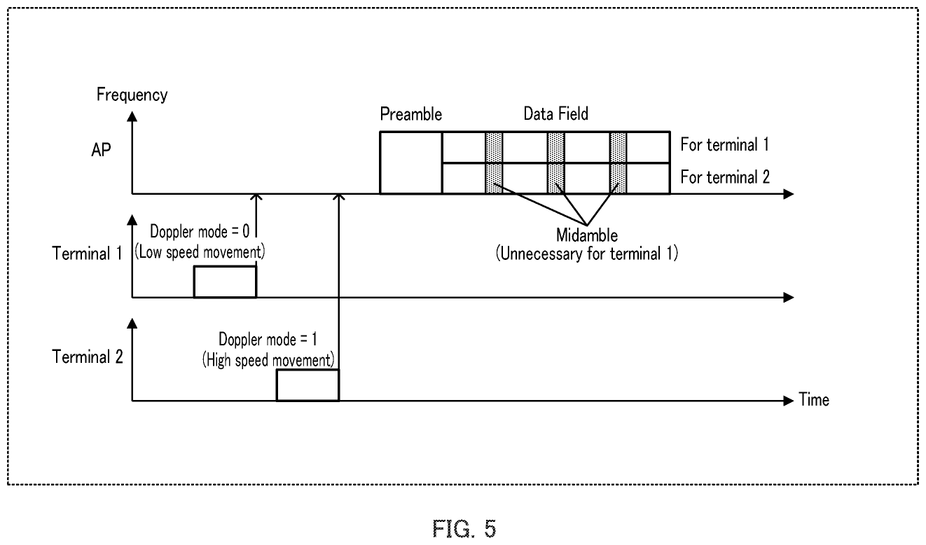

In FIG. 4, as an example, the number of padding bits is calculated according to the number of information bits of each of the four users (the terminals 1 to 4). In FIG. 4, the number of Padding bits to be added for each of the other terminals 1 to 3 is determined in line with the maximum number of information bits (and the number of Padding bits) included in the terminal 4.

For example, fading environments between terminals may differ depending on differences in moving speeds of respective terminals to be multi-user multiplexed, and the number of required Midambles may differ from terminal to terminal. For this reason, as described above, the control method which configures a common Midamble configuration in all the multi-user multiplexed terminals is inefficient, and the throughput reduces.

FIG. 5 illustrates, as an example, a case in which OFDMA multiplexing transmission from an AP to terminals 1 and 2 occurs.

In FIG. 5, for example, moving speed information (e.g., Doppler status information (for example, Doppler mode=0)) indicating low speed movement is transmitted from the terminal 1 to the AP, and moving speed information (for example, Doppler mode=1) indicating high speed movement is transmitted from the terminal 2 to the AP. In FIG. 5, for example, a Midamble is not necessary for the terminal 1 moving at the low speed, and a Midamble is necessary for the terminal 2 moving at the high speed.

Therefore, as illustrated in FIG. 5, even though the Midamble is not necessary for the terminal 1, the Midamble is necessary for the terminal 2, so that the AP configures the same Midamble configuration which has Midambles for all the OFDMA multiplexed terminals 1 and 2. In this way, even though the terminal 1 illustrated in FIG. 5 can obtain good communication performance without the Midamble due to moving at the low speed, the unnecessary Midamble is inserted into data for the terminal 1, and the throughput reduces.

Further, for example, introduction of a Midamble has been studied in NGV (Next Generation V2X) which has been studied as a next generation standard of IEEE 802.11p which is a standard for in-vehicle equipment. Although fading environments between in-vehicle terminals may also differ depending on differences in moving speeds of vehicles, detailed specifications have not yet been determined in NGV.

Therefore, in an embodiment of the present disclosure, a method for efficiently configuring Midambles for respective terminals will be described.

### Embodiment 1

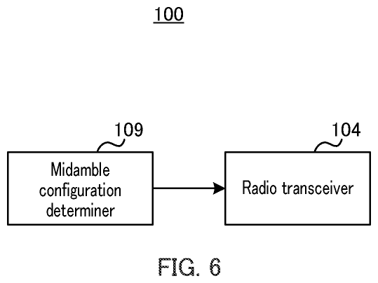

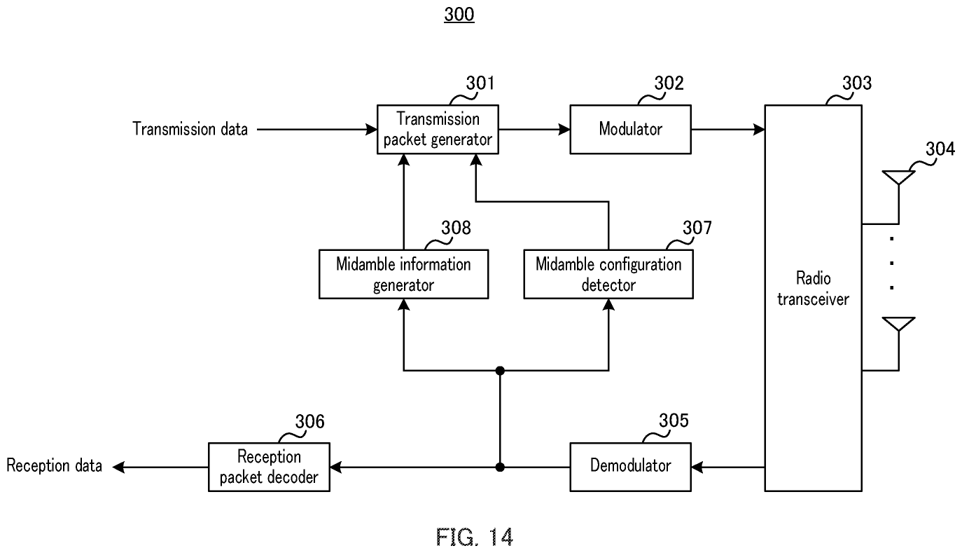

Hereinafter, Midamble control processing at the time of multi-user multiplexing in a downlink according to the present embodiment (for example, FIGS. 6 to 13 described later) and Midamble control processing at the time of multi-user multiplexing in an uplink according to the present embodiment (for example, FIGS. 14 to 18 described later) will be described, respectively.

[Downlink Midamble Control Method]

A wireless communication system according to the present embodiment includes AP 100 and terminals 200. For example, AP 100 OFDMA multiplexes data signals (downlink signals) for the plurality of terminals 200 and transmits the multiplexed data signals to the terminals 200.

FIG. 6 is a block diagram illustrating an exemplary configuration of a part of AP 100 (e.g., corresponding to a communication apparatus) according to the present embodiment.

In AP 100 illustrated in FIG. 6, Midamble configuration determiner 109 (e.g., corresponding to control circuitry) determines, for each of the plurality of terminals 200 to be user-multiplexed, a configuration of a reference signal (e.g., Midamble) to be inserted into a data field for the plurality of terminals 200. Radio transceiver 104 (e.g., corresponding to communication circuitry) performs communication processing of signals to be user-multiplexed based on the configurations of the reference signals.

[Configuration of AP]

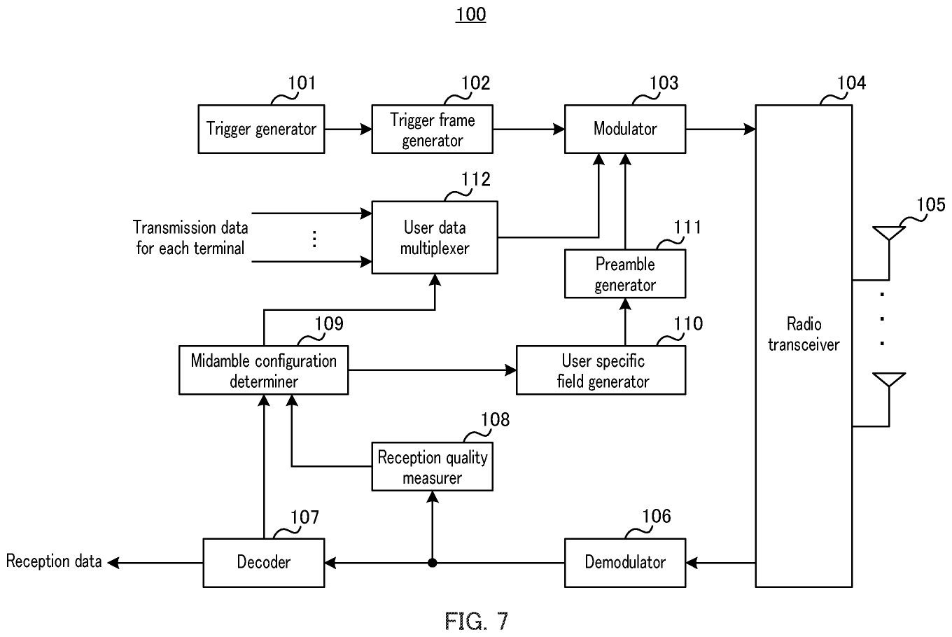

FIG. 7 is a block diagram illustrating an exemplary configuration of AP 100 according to the present embodiment.

In FIG. 7, AP 100 includes trigger generator 101, Trigger frame generaor 102, modulator 103, radio transceiver 104, antenna 105, demodulator 106, decoder 107, reception quality measurer 108, Midamble configuration determiner 109, user specific field generator 110, preamble generator 111, and user data multiplexer 112.

Trigger generator 101 generates a trigger to instruct each terminal 200 to transmit, for example, information (hereinafter, referred to as “Midamble information”) to be used for determining a Midamble configuration. For example, the Midamble information is “moving speed information” relating to the moving speed of terminal 200 or a “Midamble request” indicating whether or not a Midamble is necessary for terminal 200. It should be noted that the Midamble information may be information for determining the Midamble configuration in AP100. Trigger generator 101 outputs the generated trigger to Trigger frame generatior 102.

Trigger frame generator 102 configures a Trigger Type (e.g., a signal type) corresponding to the trigger inputted from trigger generator 101, and generates a Trigger frame which is a control signal for instructing transmission (e.g., OFDMA multiplexed transmission) of an uplink signal. NPL 3, for example, does not define a Trigger Type for instructing transmission of the Midamble information (e.g., the moving speed information or the Midamble request). In the present embodiment, for example, an unused value (or an undefined value) for the Trigger Type defined in NPL 3 may be defined as a Trigger Type corresponding to an instruction to transmit (or an instruction to collect) the Midamble information. Trigger frame generator 102 outputs the generated Trigger frame to modulator 103.

Modulator 103 performs modulation processing on the Trigger frame outputted from Trigger frame generator 102, a preamble outputted from preamble generator 111, or a data signal outputted from user data multiplexer 112. Modulator 103 outputs the modulated signal to radio transceiver 104.

Radio transceiver 104 performs radio transmission processing on the signal outputted from modulator 103, and transmits the signal after the radio transmission processing to terminal 200 via antenna 105. Further, radio transceiver 104 receives a signal transmitted from terminal 200 via antenna 105, performs radio reception processing on the received signal, and outputs the signal after the radio reception processing to demodulator 106.

Demodulator 106 performs demodulation processing on the received signal outputted from radio transceiver 104. Demodulator 106 outputs the demodulated signal to decoder 107 and reception quality measurer 108.

Decoder 107 performs decoding processing on the signal (e.g., including a preamble and data transmitted from terminal 200) outputted from demodulator 106. For example, decoder 107 outputs Midamble information (e.g., moving speed information or a Midamble request) of each terminal 200 included in the decoded signal to Midamble configuration determiner 109, and outputs the decoded data (reception data).

Reception quality measurer 108 measures a reception quality such as, for example, a fluctuation in the reception level, the signal to noise ratio (SNR), the reception error rate, or the like using the demodulated signal outputted from demodulator 106. Reception quality measurer 108 outputs reception quality information indicating the measured reception quality to Midamble configuration determiner 109.

Midamble configuration determiner 109 determines, for each of the plurality of terminals 200 to be user-multiplexed, a Midamble configuration (for example, a configuration of a reference signal (HE-LTF, etc.) to be inserted in a data field) for the plurality of terminals 200. For example, Midamble configuration determininer 109 determines the Midamble configuration for each terminal 200 based on the Midamble information of each terminal 200 outputted from decoder 107 or the reception quality information outputted from reception quality measurer 108.

A case will be described in which as an example of the moving speed information, Doppler status information (e.g., Doppler mode=0: low speed movement; Doppler mode=1: high speed movement) is transmitted from terminal 200 to AP 100. In this case, for example, Midamble configuration determiner 109 determines that a Midamble is not necessary for terminal 200 whose Doppler status information indicates the low speed movement, and configures a Midamble configuration which has no Midambles. Further, for example, Midamble configuration determiner 109 determines that a Midamble is necessary for terminal 200 whose Doppler status information indicates the high speed movement, and configures a Midamble configuration which has Midambles.

A case will be described in which as another example of the moving speed information, an estimated value of a relative moving speed between AP 100 and terminal 200 is transmitted from terminal 200 to AP 100. In this case, for example, when the estimated value of the relative moving speed is a value within a range in which the channel estimation accuracy does not deteriorate even without a Midamble, Midamble configuration determiner 109 determines that the Midamble is not necessary for corresponding terminal 200, and configures a Midamble configuration which has no Midambles. Further, for example, when the estimated value of the relative moving speed is a value within the range in which the channel estimation accuracy deteriorates without a Midamble, Midamble configuration determiner 109 determines that the Midamble is necessary for corresponding terminal 200, and configures a Midamble configuration which has Midambles.

Furthermore, when a Midamble request is communicated from terminal 200, Midamble configuration determiner 109 determines a Midamble configuration in accordance with the Midamble request (the presence or absence of a Midamble).

It should be noted that Midamble configuration determiner 109 may determine a periodicity of a Midamble within a range in which the channel estimation accuracy does not deteriorate based on, for example, the reception quality information.

Midamble configuration determiner 109 outputs Midamble configuration information indicating the determined Midamble configuration for each terminal 200 to user specific field generator 110 and user data multiplexer 112.

User specific field generator 110 configures the Midamble configuration information outputted from Midamble configuration determiner 109 in, for example, a user specific field (e.g., User Specific field) within an HE-SIG-B of a preamble. User specific field generator 110 outputs the generated information of user specific field to preamble generator 111. For example, the user specific field comprises one or more user fields containing information for each terminal 200. The Midamble configuration information for each terminal 200 is indicated to corresponding terminal 200 using the user fields corresponding to each terminal 200.

Preamble generator 111 generates, for example, a legacy preamble or an HE preamble including the user specific field within the HE-SIG-B generated by user specific field generator. Preamble generator 111 outputs the generated preamble to modulator 103.

User data multiplexer 112 user-multiplexes data to be transmitted to terminals 200 using, for example, MU-MIMO, OFDMA, or the like. For example, user data multiplexer 112 multiplexes the data (e.g., including the Midambles) to be transmitted to terminals 200 (users) based on the Midamble configurations of respective terminals 200 indicated in the Midamble configuration information inputted from Midamble configuration determiner 109. User data multiplexer 112 outputs the multiplexed signal to modulator 103.

[Configuration of Terminal]

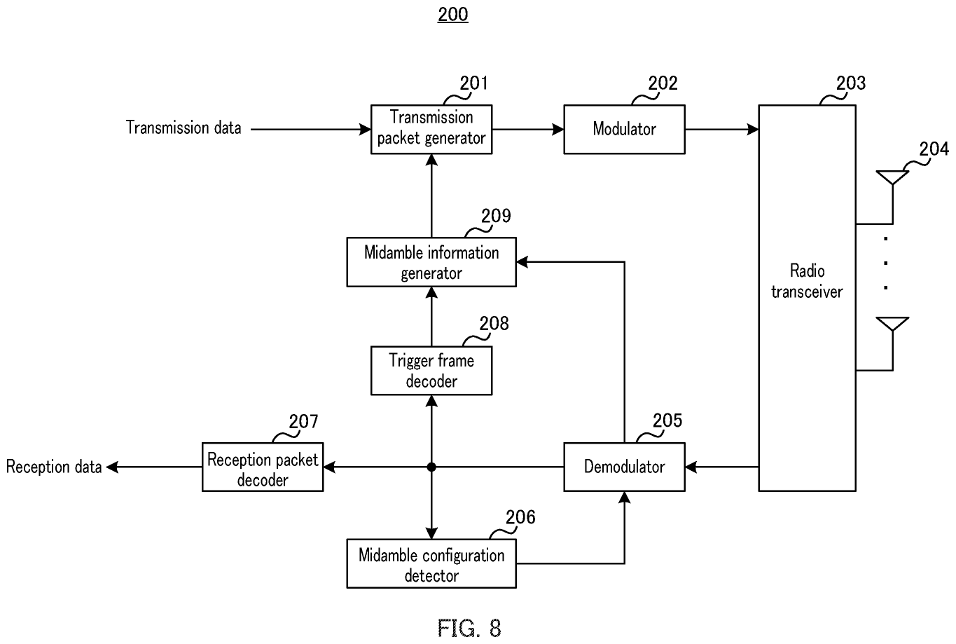

FIG. 8 is a block diagram illustrating an exemplary configuration of terminal 200 according to the present embodiment.

In FIG. 8, terminal 200 includes transmission packet generator 201, modulator 202, radio transceiver 203, antenna 204, demodulator 205, Midamble configuration detector 206, reception packet decoder 207, Trigger frame decoder 208, and Midamble information generator 209.

Transmission packet generator 201 generates a transmission packet comprising a preamble and data. The transmission packet includes, for example, Midamble information (e.g., a Midamble request or moving speed information) outputted from Midamble information generator 209. Transmission packet generator 201 outputs the generated transmission packet to modulator 202.

Modulator 202 performs modulation processing on the transmission packet outputted from transmission packet generator 201, and outputs the modulated signal to radio transceiver 203.

Radio transceiver 203 performs radio transmission processing on the signal outputted from modulator 202, and transmits the signal after the radio transmission processing to AP 100 via antenna 204. Further, radio transceiver 203 receives a signal (e.g., a Trigger frame, or a preamble and data) transmitted from AP 100 via antenna 204, performs radio reception processing on the received signal, and outputs the signal after the radio reception processing to demodulator 205.

Demodulator 205 performs demodulation processing on the signal outputted from radio transceiver 203. Demodulator 205 outputs the demodulated signal to Midamble configuration detector 206, reception packet decoder 207, Trigger frame decoder 208, and Midamble information generator 209. For example, with respect to a data field of the received signal, demodulator 205 performs the demodulation processing on the signal based on Midamble configuration information (e.g., the presence or period or a periodicity of a Midamble) outputted from Midamble configuration detector 206.

Midamble configuration detector 206 detects, from the demodulated signal (e.g., the preamble) outputted from demodulator 205, Midamble configuration information configured in a user specific field within an HE-SIG-B transmitted from AP 100. Midamble configuration detector 206 outputs the detected Midamble configuration information to demodulator 205.

Reception packet decoder 207 performs, from the demodulated signal outputted from demodulator 205, decoding processing on the preamble or data transmitted from AP 100. Reception packet decoder 207 outputs the decoded signal (reception data).

Trigger frame decoder 208 performs decoding processing of a Trigger frame transmitted from AP 100 included in the demodulated signal outputted from demodulator 205. When receiving an instruction to transmit Midamble information in the decoded Trigger frame, Trigger frame decoder 208 instructs Midamble information generator 209 to output (or generate) the Midamble information.

Midamble information generator 209 generates the Midamble information in accordance with the instruction from Trigger frame decoder 208. Midamble information generator 209 measures a relative speed between terminal 200 and AP 100 based on, for example, a level fluctuation rate of the demodulated signal outputted from demodulator 205. When receiving the instruction to transmit the Midamble information from Trigger frame decoder 208, Midamble information generator 209 outputs the Midamble information including moving speed information indicating the measured moving speed or a Midamble request to transmission packet generator 201.

It should be noted that the moving speed information may be, for example, Doppler status information (e.g., 0: low speed movement, 1: high speed movement) or an estimated value of the relative moving speed between AP 100 and terminal 200. The Midamble request is, for example, a signal indicating whether or not there is a request for a Midamble in a downlink from terminal 200 to AP 100. The Midamble information also may be, for example, a combination of the Midamble request (for example, one bit indicating the presence or absence of a Midamble) and the speed information (for example, one bit indicating the high speed or the low speed, or two or more bits indicating the relative moving speed) for determining a Midamble periodicity.

For example, in case of outputting the moving speed information, Midamble information generator 209 may output a measured value itself of the moving speed, or may determine whether terminal 200 is moving at the low speed or at the high speed from the measured value of the moving speed, and output the Doppler status information (e.g., 0: low speed movement; 1: high speed movement) based on the determination result.

In addition, in case of outputting the Midamble request, Midamble information generator 209 outputs the Midamble request indicating the absence of a Midamble when a measured value of the moving speed is a value within a range in which the channel estimation accuracy does not deteriorate even without the Midamble. Further, Midamble information generator 209 outputs the Midamble request indicating the presence of a Midamble when the measured value of the moving speed is a value within the range in which the channel estimation accuracy deteriorates without the Midamble.

It should be noted that in Midamble information generator 209, the moving speed of terminal 200 is not limited to the case in which it is determined from the level fluctuation rate of the demodulated signal. For example, when terminal 200 is mounted on an vehicle (not illustrated), Midamble information generator 209 may obtain vehicle speed information from another means such as a vehicle speed sensor, and measure the moving speed of terminal 200 based on the vehicle speed information.

[Operations of AP 100 and Terminal 200]

Next, examples of operations of AP 100 and terminal 200 according to the present embodiment will be described.

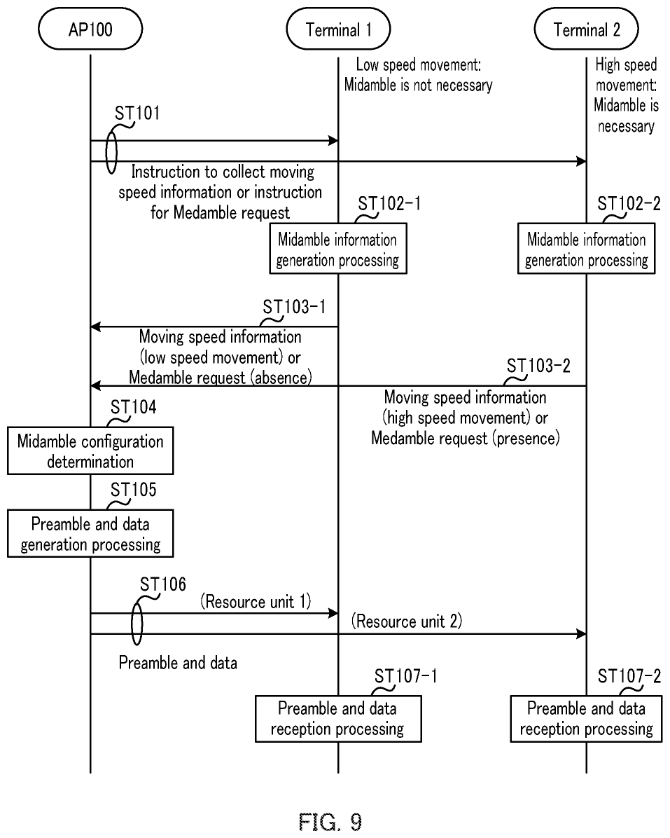

FIG. 9 is a sequence diagram illustrating exemplary Midamble control processing in multi-user multiplexing in a downlink according to the present embodiment.

Although in FIG. 9, a case will be described in which as an example, there are two terminals 200 (a terminal 1 and a terminal 2), the number of terminals 200 may be three or more.

Further, in FIG. 9, a moving speed of the terminal 1 is low, and a moving speed of the terminal 2 is high. In other words, in FIG. 9, a Midamble is not necessary for the terminal 1 and a Midamble is necessary for the terminal 2.

In FIG. 9, AP 100 signals an instruction to transmit Midamble information (e.g., an instruction to collect moving speed information or an instruction for a Midamble request) to terminals 200 (the terminal 1 and the terminal 2 in FIG. 9) (ST101). The instruction to transmit the Midamble information may be included in, for example, a Trigger frame, and defined as one of Trigger Types of the Trigger frame.

Each terminal 200 generates the Midamble information (e.g., the moving speed information or Midamble request) in response to reception of the instruction to transmit the Midamble information from AP 100 (ST102-1 and ST102-2). Each terminal 200 transmits the generated Midamble information to AP 100 (ST103-1 and ST103-2).

In the example of FIG. 9, the terminal 1 transmits the moving speed information indicating the low speed movement or the Midamble request indicating the absence of a Midamble to AP 100. On the other hand, in the example of FIG. 9, the terminal 2 transmits the moving speed information indicating the high speed movement or the Midamble request indicating the presence of a Midamble to AP 100.

It should be noted that each terminal 200 may transmit the Midamble information to AP100 based on a predetermined transmission timing (e.g., a predetermined periodicity). In this case, the instruction to transmit the Midamble information from AP 100 to terminal 200 (the processing of ST101) is not required.

AP 100 determines a Midamble configuration for each terminal 200 based on the Midamble information transmitted from each terminal 200 (ST104). For example, AP 100 determines the Midamble configuration of each terminal 200 for each resource unit (RU). In the example of FIG. 9, AP 100 configures no Midamble with respect to the terminal 1 and configures a Midamble (or a Midamble periodicity) with respect to the terminal 2.

It should be noted that AP 100 may, for example, measure a fluctuation in the reception level or the reception quality of a signal transmitted from each terminal 200, and based on the measurement result, determine the Midamble configuration of each terminal 200 for each RU. In this case, the processing for transmitting the Midamble information from terminals 200 to AP 100 (e.g., the processing of ST101, ST102-1, ST102-2, ST103-1, and ST103-2) is not required.

AP 100 generates a preamble and data based on the Midamble configurations configured in respective terminals 200 (ST105). In the example of FIG. 9, the preamble includes the Midamble configuration information for each of the terminal 1 and the terminal 2. Further, for example, a Midamble is not inserted into data for the terminal 1, and a Midamble is inserted into data for the terminal 2. AP 100 transmits the generated preamble and data to terminals 200 (ST106). In this way, AP 100 performs communication processing (here, transmission processing) of signals (data) to be user-multiplexed based on the Midamble configuration information configured in respective terminals 200.

Each terminal 200 performs reception processing on the preamble and data transmitted from AP 100 (ST107-1 and ST107-2). For example, each terminal 200 receives the data according to the Midamble configuration information included in the preamble.

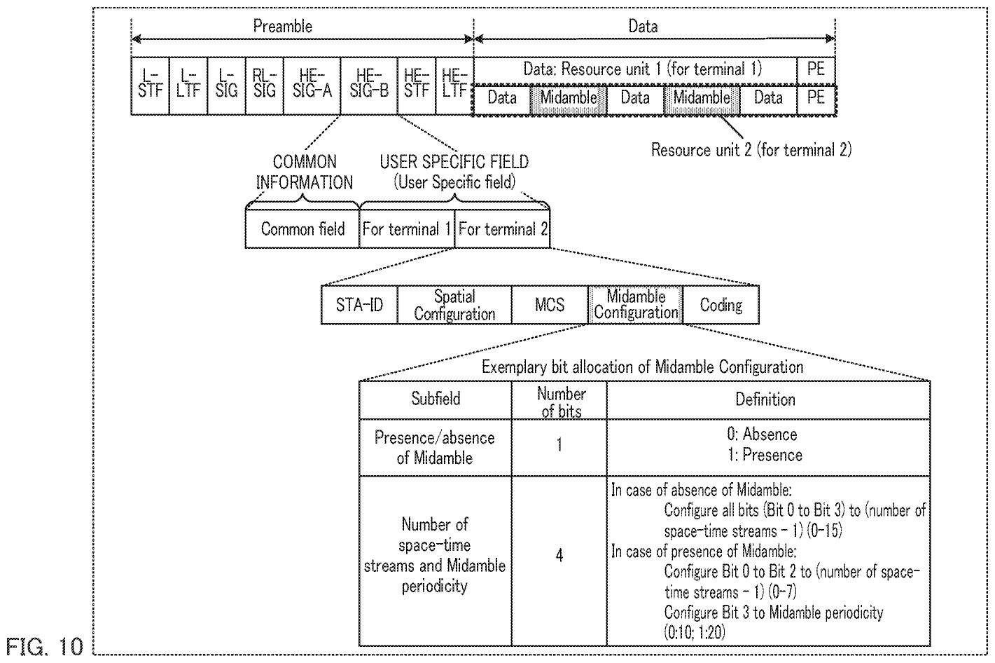

FIG. 10 illustrates an exemplary configuration of a preamble and data for the terminal 1 and the terminal 2 to be user-multiplexed in ST106 of FIG. 9.

In the example of FIG. 10, Midamble configuration information is included in a region corresponding to each terminal 200 (each of the terminal 1 and the terminal 2) of a user specific field winin an HE-SIG-B of the preamble. For example, the Midamble configuration information for the terminal 1 is configured in a “Midamble configuration” subfield within the user specific field for the terminal 1. Similarly, for example, the Midamble configuration information for the terminal 2 is configured in a “Midamble configuration” subfield within the user specific field for the terminal 2.

For example, in FIG. 9, in the Midamble configuration subfields, AP 100 configures the Midamble configuration information indicating the absence of a Midanble with respect to the terminal 1 with low speed movement, and configures the Midamble configuration information indicating the presence of a Midamble with respect to the terminal 2 with high speed movement. Further, as illustrated in FIG. 10, in the data field, AP 100 does not insert the Midamble into data for the terminal 1 with low speed movement allocated to a resource unit 1, and inserts the Midamble into data for the terminal 2 with high speed movement allocated to a resource unit 2.

Next, exemplary bit allocation in Midamble configuration information will be described.

Here, for example, the number of space-time streams in the case of the absence of a Midamble corresponds to up to 16, and the number of space-time streams in the case of the presence of a Midamble corresponds to up to 8. The reason why the number of space-time streams is restricted to up to 8 in the case of the presence of the Midamble is that reception performance cannot be ensured in the case where the number of space-time streams is as large as 16 in a high speed movement environment where a Midamble is determined to be necessary.

Further, Midamble configuration information which is defined by compounding (in other words, combining) the number of space-time streams with a Midamble periodicity will be described According to this definition, in the Midamble configuration information, the Midamble periodicity can be signaled from AP 100 to terminal 200 without increasing the number of bits regarding the Midamble periodicity.

For example, in the Midamble configuration information (or Midamble configuration subfield) illustrated in FIG. 10, “Presence/absence of Midamble (e.g., 1 bit)” and “Number of space-time streams and Midamble periodicity (e.g., 4 bits)” are configured as subfields. It should be noted that the number of bits in each field is not limited to the example illustrated in FIG. 10.

For example, in the 1 bit of the “Presence/absence of Midamble” field, “0” indicates the absence of a Midable, and “1” indicates the presence of a Midamble. It should be noted that the relationship between the value (0 or 1) of the “Presence/absence of Midamble” field and the presence or absence of a Midamble (presence or absence) may be the inverse of the relationship illustrated in FIG. 10.

Further, for example, in the 4 bits of the “Number of space-time streams and Midamble periodicity” field, information to be allocated is different depending on the presence or absence of a Midamble.

For example, as illustrated in FIG. 10, in the case of the absence of a Midamble, all the 4 bits (e.g., Bit 0 to Bit 3) correspond to the value of (the number of space-time streams−1) (any of 0 to 15). On the other hand, as illustrated in FIG. 10, in the case of the presence of a Midamble, among the 4 bits, 3 bits (for example, Bit 0 to Bit 2) correspond to the value of (the number of space-time streams−1) (any of 0 to 7), and the remaining 1 bit (for example, Bit 3) corresponds to the Midamble periodicity. In FIG. 10, “Bit 3=0” indicates “Midamble periodicity=10 [symbol]” (in other words, Midamble periodicity: small), and “Bit 3=1” indicates “Midamble periodicity=20 [symbol]” (in other words, Midamble periodicity: large). It should be noted that the Midamble periodicity is not limited to 10 or 20 [symbol], but may be another value.

For example, Midamble configuration determiner 109 determines a Midamble configuration according to a moving speed of each of the plurality of terminals 200. For example, in the Midamble configuration, the higher the moving speed of terminal 200 is, the more the number of Midambles configured in the data field is. The number of Midambles may be configured by, for example, the Midamble periodicity (M_{MA}) or an HE-LTF mode (e.g., the number of HE-LTF symbols). It should be noted that the parameter used for determining the Midamble configuration is not limited to the moving speed of terminal 200, but may be a parameter corresponding to a communication environment (e.g., fading environment) of terminal 200.

It should be noted that the bit allocation of the Midamble configuration illustrated in FIG. 10 is merely an example, and is not limited to the allocation illustrated in FIG. 10. For example, the number of bits of the Midamble configuration information is not limited to 5 bits, but may be another number of bits. Further, the number of space-time streams that can be configured in terminal 200 (e.g., an upper limit) is not limited to 16 or 8, but may be another value. In addition, in the case of the presence of a Midamble, the bit allocation of the number of space-time streams (3 bits in FIG. 10) and the Midamble periodicity (1 bit in FIG. 10) in the “Number of space-time streams and Midamble periodicity” field is not limited to the example illustrated in FIG. 10.

Further, as illustrated in FIG. 10, in the Midamble configuration information, the number of space-time streams and the Midamble periodcity are not limited to the case in which the number of space-time streams and the Midamble periodicity are compoundly defined, but the number of space-time streams and the Midamble periodicity may be defined individually.

Further, for example, in the “Number of space-time streams and Midamble periodicity” field, a limit (e.g., upper limit) of the number of space-time streams may be variably configured depending on the magnitude of the Midamble periodicity in the case of the presence of a Midamble. For example, when the Midamble periodicity is long, the number of space-time streams may be limited to up to 8, and when the Midamble periodicity is short, the number of space-time streams may be limited to up to 4.

Next, the number of HE-LTF symbols in a Midamble (see, for example, FIG. 1) will be described.

In the present embodiment, the number of HE-LTF symbols in a Midamble is not set to the maximum of sums of the number of space-time streams for each RU (see, for example, FIG. 3) in common to all the RUs, but set for each RU respectively to the number corresponding to a sum of the number of space-time streams for each RU.

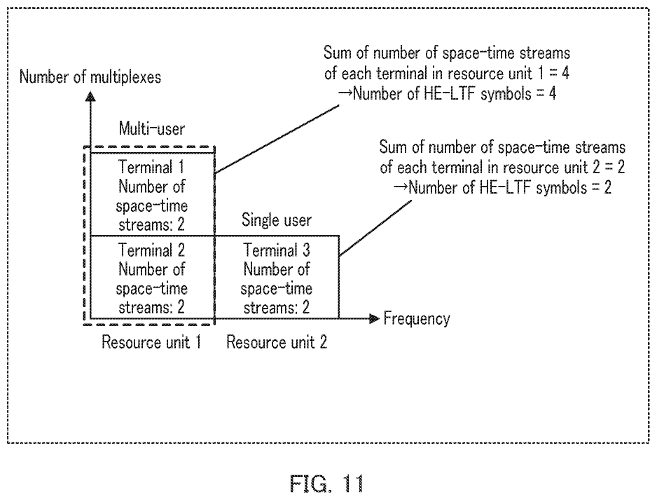

For example, FIG. 11 illustrates an exemplary configuration of the number of HE-LTF symbols when a multi-user multiplexed resource unit 1 and a single-user resource unit 2 are mixed according to the present embodiment.

It should be noted that AP 100 (e.g., Midamble configuration determiner 109) determines the same Midamble configuration among terminals 200 to be MU-MIMO multiplexed. On the other hand, AP 100 determines a Midamble configuration suitable for each terminal moving speed among terminals 200 to be OFDMA multiplexed. For example, in the resource unit 1 illustrated in FIG. 11, the same Midamble configuration is determined for the terminal 1 and the terminal 2 to be MU-MIMO multiplexed. On the other hand, for example, Midamble configurations corresponding to moving speeds of respective terminals 200 are determined for the terminal 1 and the terminal 2 assigned to the resource unit 1 illustrated in FIG. 11 and the terminal 3 assigned to the resource unit 2.

For example, in FIG. 11, the sum of the number of space-time streams of the terminal 1 and the terminal 2 assigned to the resource unit 1 is 4, and the number of space-time streams of the terminals 3 assigned to the resource unit 2 is 2. In this case, the number of HE-LTF symbols in a Midamble in the resource unit 1 is set to 4, and the number of HE-LTF symbols in a Midamble in the resource unit 2 is set to 2 (see, for example, FIG. 2).

As illustrated in FIG. 11, in the present embodiment, when the sum of the number of space-time streams for each resource unit differs, the number of HE-LTF symbols to be used for each resource unit is configured based on the sum of the number of space-time streams for each resource unit.

For example, compare the present embodiment (see, for example, FIG. 11) with FIG. 3. In FIG. 3, in the single-user resource unit 2, even though the number of space-time streams is 2, the number of HE-LTF symbols is set to 4 common to the other resource unit 1. On the other hand, in the present embodiment, as illustrated in FIG. 11, in the single-user resource unit 2, the number of HE-LTF symbols is set to 2 corresponding to the number of space-time streams (2).

Thus, in the resource unit 2 illustrated in FIG. 11, it is possible to prevent the increase in overhead due to the Midambles as compared with FIG. 3. In other words, in the present embodiment, in a certain resource unit, it is possible to appropriately configure the number of HE-LTF symbols according to the number of space-time streams in the resource unit regardless of the number of space-time streams in other resource units.

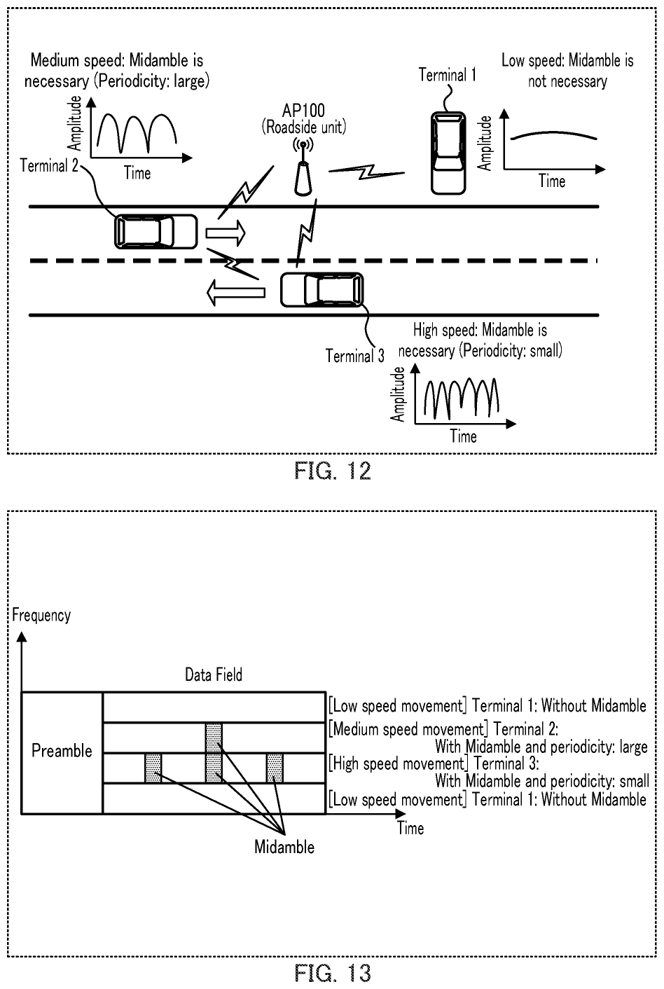

Next, for example, FIG. 12 illustrates an example (e.g., a V2X environment) in which a plurality of terminals 200 having different moving speeds are mixed in user-multiplexing in AP 100 (e.g., a roadside unit).

In FIG. 12, a terminal 1 is moving at a low speed (or stops) (e.g., low speed fading environment), a terminal 2 is moving at a medium speed (e.g., medium speed fading environment), and a terminal 3 is moving at a high speed (e.g., fast speed fading environment). In this case, in determining Midamble configurations, AP 100 configures, for example, no Midamble with respect to the terminal 1, a Midamble and a large Midamble periodicity with respect to the terminal 2, and a Midamble and a small Midamble periodicity with respect to the terminal 3.

FIG. 13 illustrates exemplary Midamble configurations in the terminal 1, the terminal 2, and the terminal 3 configured in FIG. 12. As illustrated in FIG. 13, for each of the terminals 1 to 3 to be user-multiplexed, a different Midamble configuration is configured.

For example, as illustrated in FIG. 13, a Midamble is not inserted in a data field for the terminal 1 moving at the low speed. As a result, the Midamble that is not necessary for the terminal 1 can be reduced, and the throughput for the terminal 1 can be improved.

Further, as illustrated in FIG. 13, Midambles are inserted into a data field for the terminal 3 moving at the high speed with a periodicity shorter than that for the terminal 2. As a result, in the terminal 3, the channel estimation accuracy can be improved using the Midambles, and the throughput for the terminal 3 can be improved.

Furthermore, as illustrated in FIG. 13, a Midamble is inserted into a data field for the terminal 2 moving at the medium speed with the periodicity longer than for the terminal 3. As a result, the channel estimation accuracy can be improved and the throughput for the terminal 2 can be improved without excessively inserting Midambles more than the number of Midambles suitable for the moving speed of the terminal 2.

In this way, according to the present embodiment, AP 100 determines a Midamble configuration for each terminal 200 and performs user multiplexing. With this processing, for example, even in the case where terminals 200 having different moving speeds are mixed in the downlink user multiplexing, it is possible to configure a Midamble configuration according to a communication environment of each terminal 200. Therefore, according to the present embodiment, it is possible to efficiently configure a Midamble configuration for each of the plurality of terminal 200s to be user-multiplexed for the plurality of terminals 200, and the throughput of each terminal 200 can be improved.

In addition, in a multi-user transmission including RUs (in other words, terminals 200) having different Midamble configurations, it is preferable that an HE-LTF mode within a Midamble is a mode having the same length as data symbols (for example, 4×HE-LTF in the case of 802.11ax), regardless of an HE-LTF mode of a preamble. For example, when a data symbol and a Midamble symbol are mixed among RUs, inter-RU interference or inter-carrier interference at the time of demodulating in terminal 200 can be prevented by aligning periods in which the data symbol and the Midamble symbol are mixed.

Further, when inter-RU interference between a Midamble symbol and a data symbol is not problematic (for example, when the impact of the inter-RU interference is small), a different mode may be configured in an HE-LTF mode within a Midamble (for example, 1×/2×/4×HE-LTF) depending on a channel environment of each terminal 200. For example, as in an 80+80 MHz band, in the case of transmission using a frequency band obtained by combining a plurality of separated bands, it is easy to perform reception processing individually for each band at terminal 200. Therefore, AP 100 may allow mixing of different Midamble configurations in a band assigned to terminal 200, and may provide an RU without a Midamble. For example, AP 100 may include an RU having a Midamble configuration for high speed movement in one 80 MHz band of the 80+80 MHz band to insert a Midamble of 2×HE-LTF therein, and may insert a Midamble of 4×LTF in the other 80 MHz band.

The downlink Midamble control method has been described above.

[Uplink Midamble Control Method]

Next, an uplink Midamble control method will be described.

A wireless communication system according to the present embodiment includes terminals 300 and AP 400. For example, AP100 receives a data signal (uplink signal) of the plurality of terminals 300 that are OFDMA multiplexed.

[Configuration of Terminal]

FIG. 14 is a block diagram illustrating an exemplary configuration of terminal 300 according to the present embodiment.

In FIG. 14, terminal 300 includes transmission packet generator 301, modulator 302, radio transceiver 303, antenna 304, demodulator 305, reception packet decoder 306, Midamble configuration detector 307, and Midamble information generator 308.

Transmission packet generator 301 generates a transmission packet comprising a preamble and data. The transmission packet includes, for example, Midamble information (e.g., a Midamble request or moving speed information) outputted from Midamble information generator 308. Also, transmission packet generator 301 determines arrangement of transmission data (e.g., including a Midamble) in a data field within the transmission packet based on Midamble configuration information outputted from Midamble configuration detector 307. Transmission packet generator 301 outputs the generated transmission packet to modulator 302.

Modulator 302 performs modulation processing on the transmission packet outputted from transmission packet generator 301, and outputs the modulated signal to radio transceiver 303.

Radio transceiver 303 performs radio transmission processing on the signal (e.g., Midamble information, or a preamble and data) outputted from modulator 302, and transmits the signal after the radio transmission processing to AP 400 via antenna 304. Further, radio transceiver 303 receives a signal (e.g., a Trigger frame) transmitted from AP 400 via antenna 304, performs radio reception processing on the received signal, and outputs the signal after the radio reception processing to demodulator 305.

Demodulator 305 performs demodulation processing on the signal outputted from radio transceiver 303. Demodulator 305 outputs the demodulated signal to reception packet decoder 306, Midamble configuration detector 307, and Midamble information generator 308.

Reception packet decoder 306 performs, from the demodulated signal outputted from demodulator 305, decoding processing on the preamble or data transmitted from AP 400. Reception packet decoder 306 outputs the decoded signal (reception data).

Midamble configuration detector 307 detects Midamble configuration information configured in a field (e.g., User Info field) within per terminal information of the Trigger frame transmitted from AP 400, the Midamble configuration information being included in the demodulated signal outputted from demodulator 305. Midamble configuration detector 307 outputs the detected Midamble configuration information to transmission packet generator 301.

Midamble information generator 308 generates Midamble information. Midamble information generator 308 measures a relative speed between terminal 300 and AP 400 based on, for example, a level fluctuation rate of the demodulated signal outputted from demodulator 305. Midamble information generator 308 outputs the Midamble information including moving speed information indicating the measured moving speed or a Midamble request to transmission packet generator 301.

It should be noted that the moving speed information or the Midamble request included in the Midamble information generated by Midamble information generator 308 may be the same as the moving speed information or the Midamble request generated by Midamble information generator 209 illustrated in FIG. 8, for example.

Further, in Midamble information generator 308, the moving speed of terminal 300 is not limited to the case in which it is determined from the level fluctuation rate of the demodulated signal. For example, when terminal 300 is mounted on an vehicle (not illustrated), Midamble information generator 308 may obtain a vehicle speed information from another means such as a vehicle speed sensor, and measure the moving speed of terminal 300 based on the vehicle speed information.

[Configuration of AP]

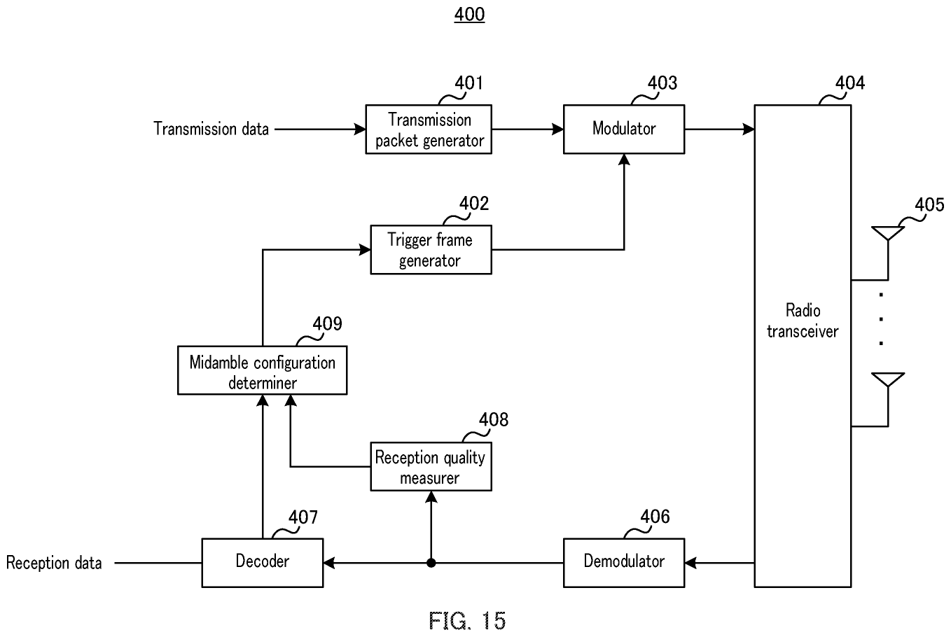

FIG. 15 is a block diagram illustrating an exemplary configuration of AP 400 according to the present embodiment.

In FIG. 15, AP 400 includes transmission packet generator 401, Trigger frame generator 402, modulator 403, radio transceiver 404, antenna 405, demodulator 406, decoder 407, reception quality measurer 408, and Midamble configuration determiner 409.

In AP 400 illustrated in FIG. 15, Midamble configuration determiner 409 (e.g., corresponding to control circuitry) determines, for each of the plurality of terminals 300 to be user-multiplexed, a configuration of a reference signal (e.g., Midamble) to be inserted into a data field for the plurality of terminals 300. Radio transceiver 404 (e.g., corresponding to communication circuitry) performs communication processing (e.g., reception processing) of signals user-multiplexed based on the configurations of the reference signals.

For example, transmission packet generator 401 generates a transmission packet comprising a preamble and data. Transmission packet generator 401 outputs the generated transmission packet to modulator 403.

Trigger frame generator 402 configures Midamble configuration information outputted from Midamble configuration determiner 409 in, for example, a field within per terminal information, and generates a Trigger frame. For example, NPL 3 does not define a field (or subfield) corresponding to the Midamble configuration within the per terminal information of the Trigger frame. In the present embodiment, for example, the field corresponding to the Midamble configuration may be defined in addition to the fields defined in NPL 3. Trigger frame generator 402 outputs the generated Trigger frame to modulator 403.

Modulator 403 performs modulation processing on the transmission packet outputted from transmission packet generator 401 or the Trigger frame outputted from Trigger frame generator 402. Modulator 403 outputs the modulated signal to radio transceiver 404.

Radio transceiver 404 performs radio transmission processing on the signal outputted from modulator 403, and transmits the signal after the radio transmission processing to terminal 300 via antenna 405. Further, radio transceiver 404 receives a signal transmitted from terminal 300 via antenna 405, performs radio reception processing on the received signal, and outputs the signal after the radio reception processing to demodulator 406.

Demodulator 406 performs demodulation processing on the received signal outputted from radio transceiver 404. Demodulator 406 outputs the modulated signal to decoder 407 and reception quality measurer 408.

Decoder 407 performs decoding processing on the signal (e.g., including a preamble and data transmitted from terminal 300) outputted from demodulator 406. For example, decoder 407 outputs Midamble information (e.g., moving speed information or a Midamble request) of each terminal 200 included in the decoded signal to Midamble configuration determiner 409, and outputs the decoded data (reception data).

Reception quality measurer 408 measures a reception quality such as, for example, a fluctuation in the reception level, the signal to noise ratio (SNR), the reception error rate, or the like using the demodulated signal outputted from demodulator 406. Reception quality measurer 408 outputs reception quality information indicating the measured reception quality to Midamble configuration determiner 409.

Midamble configuration determiner 409 determines, for each of the plurality of terminals 300 to be user-multiplexed, a Midamble configuration (for example, a configuration of a reference signal (HE-LTF, etc.) to be inserted in a data field) for the plurality of terminals 300. For example, Midamble configuration determininer 409 determines the Midamble configuration for each terminal 300 based on the Midamble information of each terminal 300 outputted from decoder 407 or the reception quality information outputted from reception quality measurer 408.

A case will be described in which as an example of the moving speed information, Doppler status information (e.g., Doppler mode=0: low speed movement; Doppler mode=1: high speed movement) is transmitted from terminal 300 to AP 400. In this case, for example, Midamble configuration determiner 409 determines that a Midamble is not necessary for terminal 300 whose Doppler status information indicates the low speed movement, and configures a Midamble configuration which has no Midambles. Further, for example, Midamble configuration determiner 409 determines that a Midamble is necessary for terminal 300 whose Doppler status information indicates the high speed movement, and configures a Midamble configuration which has Midambles.

A case will be described in which as another example of the moving speed information, an estimated value of a relative moving speed between AP 400 and terminal 300 is transmitted from terminal 300 to AP 400. In this case, for example, when the estimated value of the relative moving speed is a value within a range in which the channel estimation accuracy does not deteriorate even without a Midamble, Midamble configuration determiner 409 determines that the Midamble is not necessary for corresponding terminal 300, and configures a Midamble configuration which has no Midambles. Further, for example, when the estimated value of the relative moving speed is a value within the range in which the channel estimation accuracy deteriorates without a Midamble, Midamble configuration determiner 409 determines that the Midamble is necessary for corresponding terminal 300, and configures a Midamble configuration which has Midambles.

Furthermore, when a Midamble request is communicated from terminal 300, Midamble configuration determiner 409 determines a Midamble configuration in accordance with the Midamble request (the presence or absence of a Midamble).

It should be noted that Midamble configuration determiner 409 may determine a periodicity of a Midamble within a range in which the channel estimation accuracy does not deteriorate based on, for example, the reception quality information.

Midamble configuration determiner 409 outputs Midamble configuration information indicating the determined Midamble configuration for each terminal 300 to Trigger frame generator 402.

[Operations of Terminal 300 and AP 400]

Next, examples of operations of terminal 300 and AP 400 according to the present embodiment will be described.

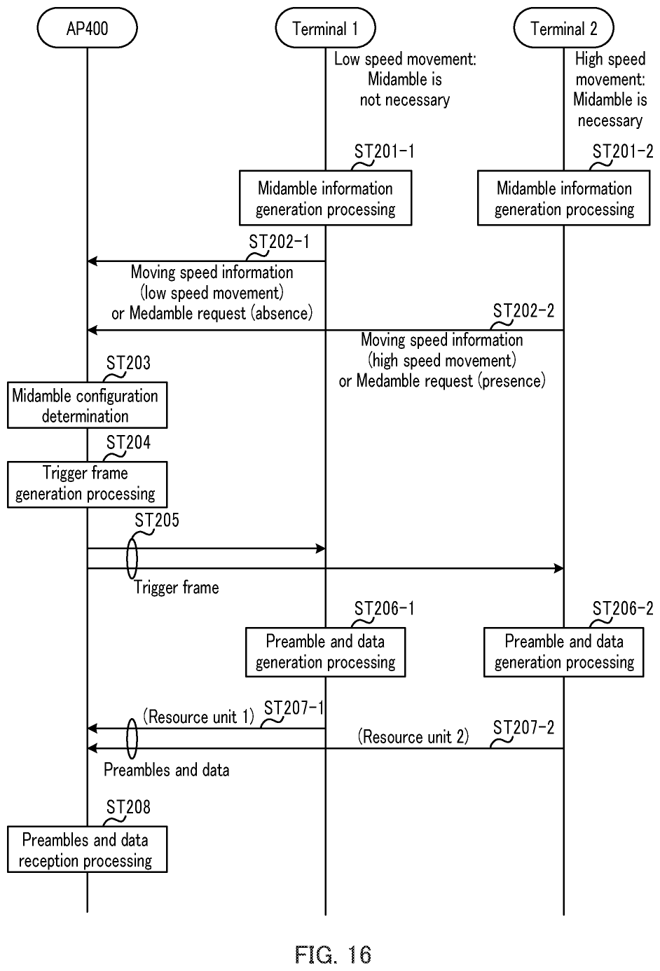

FIG. 16 is a sequence diagram illustrating exemplary Midamble control processing in multi-user multiplexing in an uplink according to the present embodiment.

Although in FIG. 16, a case will be described in which as an example, there are two terminals 200 (a terminal 1 and a terminal 2), the number of terminals 200 may be three or more.

Further, in FIG. 16, a moving speed of the terminal 1 is low, and a moving speed of the terminal 2 is high. In other words, in FIG. 16, a Midamble is not necessary for the terminal 1 and a Midamble is necessary for the terminal 2.

In FIG. 16, each terminal 300 generates Midamble information (e.g., moving speed information or a Midamble request) (ST201-1 and ST201-2). Each terminal 300 transmits the generated Midamble information to AP 400 (ST202-1 and ST202-2).

In the example of FIG. 16, the terminal 1 transmits moving speed information indicating the low speed movement or a Midamble request indicating the absence of a Midamble to AP 400. On the other hand, in the example of FIG. 16, the terminal 2 transmits movement speed information indicating the high speed movement or a Midamble request indicating the presence of a Midamble to AP 400.

It should be noted that Each terminal 300 may transmit the Midamble information (e.g., the moving speed information or Midamble request) in response to reception of an instruction (e.g., an instruction to transmit the Midamble information; not illustrated) from AP 400, or may transmit the Midamble information to AP 400 based on a predetermined transmission timing (e.g., a predetermined periodicity).

AP 400 determines a Midamble configuration for each terminal 300 based on the Midamble information transmitted from each terminal 300 (ST203). For example, AP 400 determines the Midamble configuration of each terminal 300 for each RU. In the example of FIG. 16, AP 400 configures no Midamble with respect to the terminal 1 and configures a Midamble (or a Midamble periodicity) with respect to the terminal 2.

It should be noted that AP 400, for example, may measure a fluctuation in the reception level or the reception quality of a signal transmitted from each terminal 300, and based on the measurement result, determine the Midamble configuration of each terminal 300 for each RU. In this case, the processing for transmitting the Midamble information from terminals 300 to AP 400 (e.g., the processing of ST201-1, ST201-2, ST202-1, and ST202-2) is not required.

AP 400 configures the Midamble configuration information indicating the Midamble configuration configured in each terminal 300 in, for example, a Midamble configuration field within per terminal information of a Trigger frame, and generates the Trigger frame (ST204). AP 400 transmits the generated Trigger frame to respective terminals 300 (ST205).

Each terminal 300 generates a preamble and data based on, for example, the Midamble configuration information configured for each terminal 300 included in the Trigger frame (ST206-1 and ST206-2). In the example of FIG. 16, the terminal 1 does not insert a Midamble into a data field, and the terminal 2 inserts a Midamble into a data field. Each terminal 300 transmits the generated preamble and data to AP 400 (ST207-1 and ST207-2).

AP 400 performs reception processing on the preambles and data transmitted from respective terminals 300 (ST208). For example, AP 400 receives the data according to the Midamble configuration information configured with respect to respective terminals 300. In this way, AP 400 performs communication processing (here, reception processing) of the signals (data) user-multiplexed based on the Midamble configuration information in respective terminals 300.

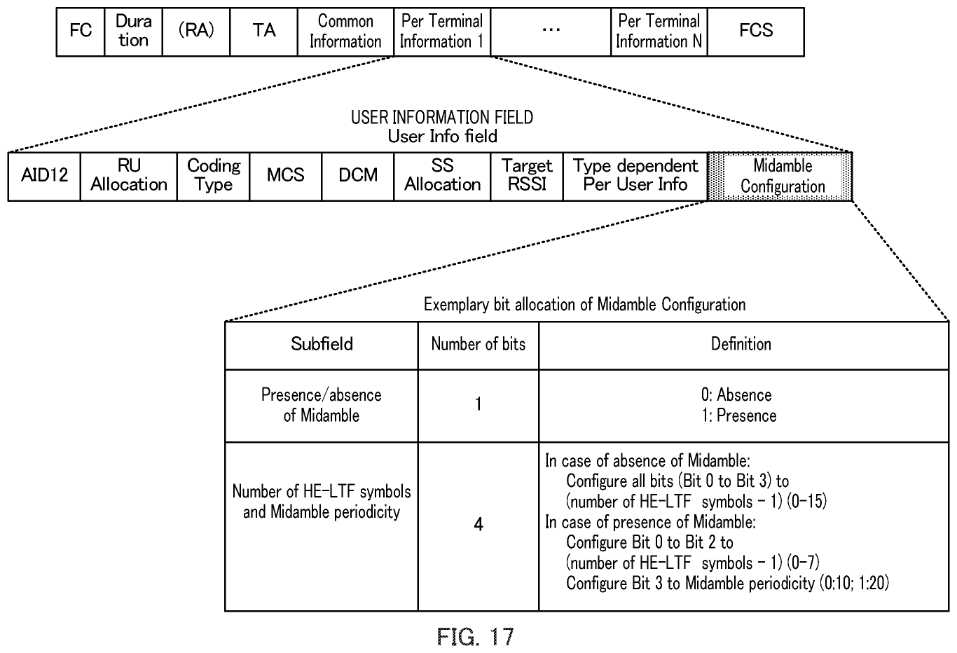

FIG. 17 illustrates an exemplary configuration of a Trigger frame signaled from AP 400 to respective terminals 300 in ST205 of FIG. 16.

In the example of FIG. 17, Midamble configuration information is included in a region corresponding to each terminal 300 (each of the terminal 1 and the terminal 2) of a per terminal information field (user information field) of the Trigger frame. For example, the Midamble configuration information for the terminal 1 is configured in a “Midamble configuration” subfield within a per terminal information 1 field for the terminal 1. Similarly, for example, the Midamble configuration information for the terminal 2 is configured in a “Midamble configuration” subfield in a per terminal information 2 field for the terminal 2.

For example, in the example of FIG. 16, in the Midamble configuration subfields, AP 400 configures the Midamble configuration information indicating the presence of a Midamble with respect to the terminal 1 with low speed movement, and configures the Midamble configuration information indicating the presence of a Midamble with respect to the terminal 2 with high speed movement.

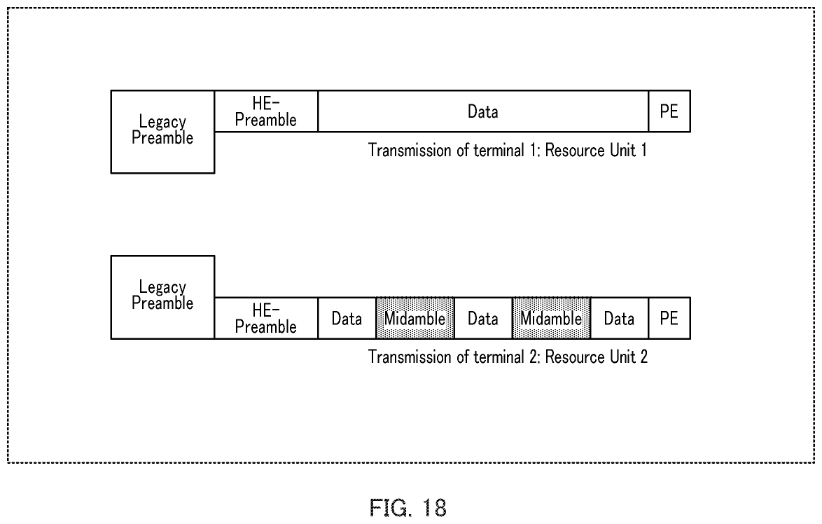

FIG. 18 illustrates exemplary configurations of transmission packets (e.g., preambles and data) transmitted from the terminal 1 and the terminal 2 user-multiplexed in ST207-1 and ST207-2 of FIG. 16.

As illustrated in FIG. 18, the terminal 1 moving at the low speed does not insert a Midamble into data allocated to the resource unit 1 in the data field. On the other hand, as illustrated in FIG. 18, the terminal 2 moving at the high speed inserts a Midamble into data allocated to the resource unit 2 in the data field.

Next, exemplary bit allocation in Midamble configuration information will be described.

Here, as an example, the number of space-time streams in the case of the absence of a Midamble corresponds to up to 16, and the number of space-time streams in the case of the presence of a Midamble corresponds to up to 8, similarly to the example in the downlink control method described above.

Further, Midamble configuration information which is defined by compounding (in other words, combining) the number of HE-LTF symbols with a Midamble periodicity will be described According to this definition, the Midamble periodicity can be signaled from AP 100 to terminal 200 without increasing the number of bits regarding the number of HE-LTF symbols.

For example, in the Midamble configuration information (or Midamble configuration subfield) illustrated in FIG. 17, “Presence/absence of Midamble (e.g., 1 bit)” and “Number of HE-LTFsymbols and Midamble periodicity (e.g., 4 bits)” are configured as subfields. It should be noted that the number of bits in each field is not limited to the example illustrated in FIG. 17.

For example, in the 1 bit of the “Presence/absence of Midamble” field, “0” indicates the absence of a Midable, and “1” indicates the presence of a Midamble. It should be noted that the relationship between the value (0 or 1) of the field “Presence/absence of Midamble” and the presence or absence of a Midamble (presence or absence) may be the inverse of the relationship illustrated in FIG. 17.

Further, for example, in the 4 bits of the “Number of HE-LTF symbols and Midamble periodicity” field, information to be allocated is different depending on the presence or absence of a Midamble.

For example, as illustrated in FIG. 17, in the case of the absence of a Midamble, all the 4 bits (e.g., Bit 0 to Bit 3) correspond to the value of (the number of HE-LTF symbols−1) (any of 0 to 15). On the other hand, as illustrated in FIG. 17, in the case of the presence of a Midamble, among the 4 bits, 3 bits (for example, Bit 0 to Bit 2) correspond to the value of (the number of HE-LTF symbols−1) (any of 0 to 7), and the remaining 1 bit (for example, Bit 3) corresponds to the Midamble periodicity. In FIG. 17, “Bit 3=0” indicates “Midamble periodicity=10 [symbol]” (in other words, Midamble periodicity: small), and “Bit 3=1” indicates “Midamble periodicity=20 [symbol]” (in other words, Midamble periodicity: large). It should be noted that the Midamble periodicity is not limited to 10 or 20 [symbol], but may be another value.

For example, Midamble configuration determiner 409 determines a Midamble configuration according to a moving speed of each of the plurality of terminals 300. For example, in the Midamble configuration, the higher the moving speed of terminal 300 is, the more the number of Midambles configured in the data field is. The number of Midambles may be configured by, for example, the Midamble periodicity (M_{MA}) or an HE-LTF mode (e.g., the number of HE-LTF symbols). It should be noted that the parameter used for determining the Midamble configuration is not limited to the moving speed of terminal 300, but may be a parameter corresponding to a communication environment (e.g., fading environment) of terminal 300.

It should be noted that the bit allocation of the Midamble configuration illustrated in FIG. 17 is merely an example, and is not limited to the allocation illustrated in FIG. 17. For example, the number of bits of the Midamble configuration information is not limited to 5 bits, but may be another number of bits. Further, the number of HE-LTF symbols that can be configured in terminal 300 (e.g., an upper limit) is not limited to 16 or 8, but may be another value. In addition, in the case of the presence of a Midamble, the bit allocation of the number of HE-LTF symbols (3 bits in FIG. 17) and the Midamble periodicity (1 bit in FIG. 17) in the “Number of HE-LTFsymbols and Midamble periodicity” field is not limited to the example illustrated in FIG. 17.

Further, as illustrated in FIG. 17, in the Midamble configuration information, the number of HE-LTFsymbols and the Midamble periodcity are not limited to the case in which the number of HE-LTFsymbols and the Midamble periodicity are compoundly defined, but the number of HE-LTFsymbols and the Midamble periodicity may be defined individually.

In this way, according to the present embodiment, AP 400 determines a Midamble configuration for each terminal 300, and each terminal 300 transmits (e.g., user-multiplexes) an uplink signal based on the Midamble configuration determined for each terminal 300. With this processing, for example, even in the case where terminals 300 having different moving speeds are mixed in the uplink user multiplexing, it is possible to configure a Midamble configuration according to a communication environment of each terminal 300. Therefore, according to the present embodiment, it is possible to efficiently configure a Midamble configuration for each of the plurality of terminals 300 to be user-multiplexed for the plurality of terminals 300, and the throughput of each terminal 300 can be improved.

For example, a Midamble that is not necessary for terminal 300 moving at a low speed can be reduced, and the throughput for this terminal 300 can be improved. Further, by inserting a Midamble for terminal 300 moving at a high speed, the channel estimation accuracy can be improved and the throughput can be improved.

The uplink Midamble control method has been described above.

In this way, in the present embodiment, an AP (e.g., AP 100 or AP 400) determines, for each of a plurality of terminals (e.g., terminals 200 or terminals 300) to be user-multiplexed, a configuration of a Midamble inserted into a data field for the plurality of terminals, and performs communication processing of signals to be user-multiplexed based on the determined the configurations of the Midambles. Further, the terminal (e.g., terminal 200 or terminal 300) performs communication processing based on, for example, the Midamble configuration configured according to a communication environment for each terminal.

As a result, in the present embodiment, the AP can appropriately configure the Midamble configuration for each terminal according to the communication environment (e.g., moving speed) for each terminal. With this configuration, for example, a Midamble that is not necessary for a terminal moving at a low speed can be reduced, and the throughput can be improved. Further, for example, the channel estimation accuracy for a terminal moving at a high speed can be improved, and the throughput can be improved.

Also in NGV (Next Generation V2X) which has been studied as a next generation standard of IEEE 802.11p which is an a standard for in-vehicle equipment, the throughput of each terminal can be improved by configuring a Midamble configuration for each terminal depending on fading environments between in-vehicle terminals due to, for example, differences in moving speeds of vehicles.

It should be noted that in the present embodiment, the case in which the Midamble configuration includes the number of space-time streams in the downlink Midamble control, and the case in which the Midamble configuration includes the number of HE-LTF symbols in the uplink Midamble control have been described. However, in the present embodiment, the Midamble configuration may include the number of space-time streams or the number of HE-LTF symbols.

### Embodiment 2

In the present embodiment, conditions are assumed in which the number of information bits for each terminal differs, and a redundancy such as the number of Padding bits for OFDMA multiplexing in a data field differs between terminals (see, for example, FIG. 4).

In the present embodiment, a method of replacing a portion corresponding to the redundancy in the data field with a Midamble and utilizing the same will be described.

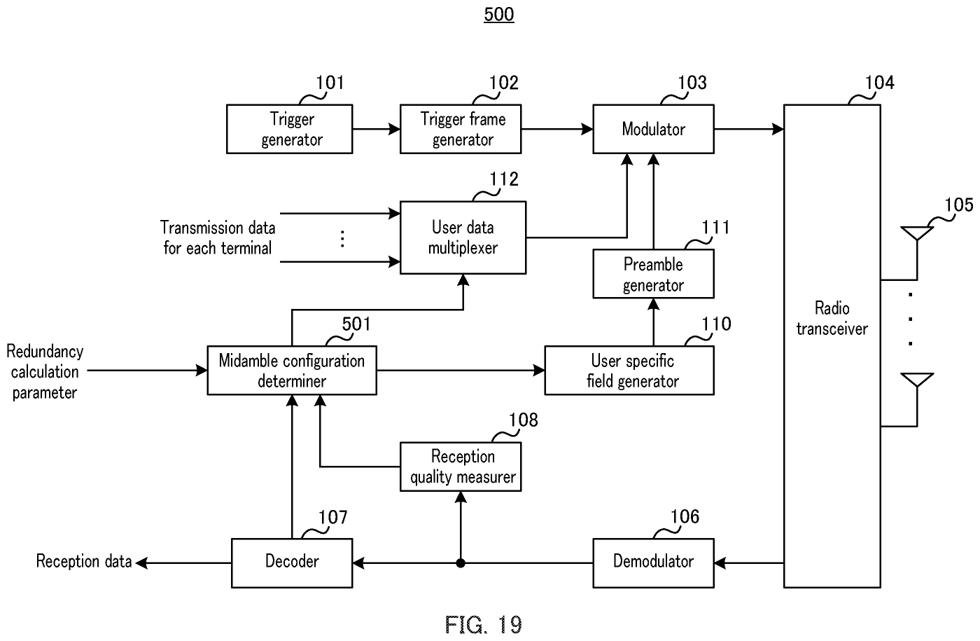

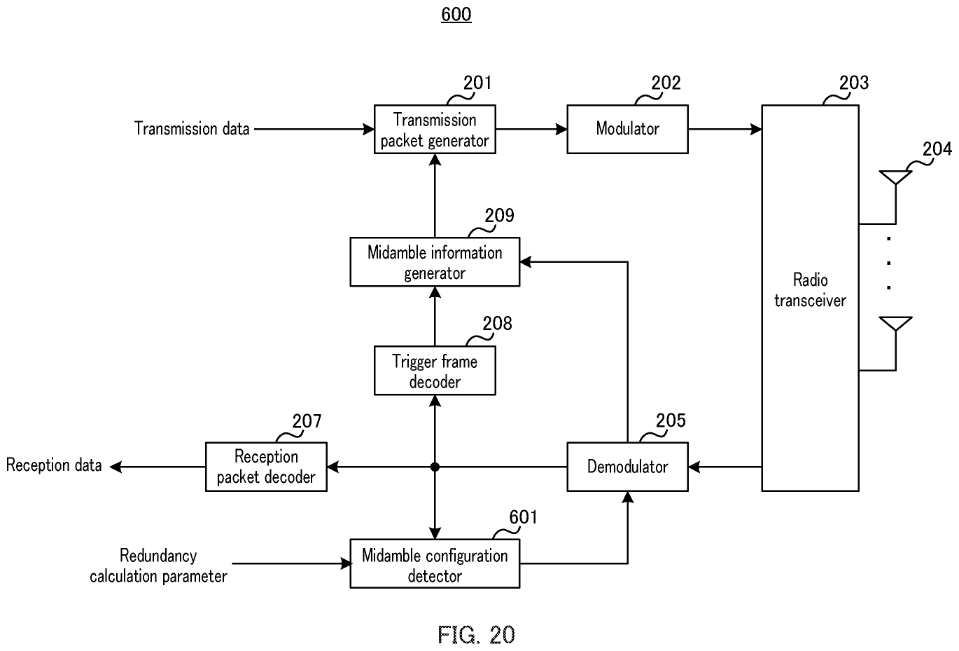

FIG. 19 is a block diagram illustrating an exemplary configuration of AP 500 according to the present embodiment. FIG. 20 is a block diagram illustrating an exemplary configuration of terminal 600 according to the present embodiment. It should be noted that in FIGS. 19 and 20, the same reference numerals denote the same configurations as in Embodiment 1 (e.g., FIGS. 7 and 8), and the description thereof will be omitted.

For example, in AP 500 illustrated in FIG. 19, operations of Midamble configuration determiner 501 differ from those of Embodiment 1. Further, in terminal 600 illustrated in FIG. 20, operations of Midamble configuration detector 601 differs from those of Embodiment 1.

In AP 500 illustrated in FIG. 19, Midamble configuration determiner 501 (e.g., corresponding to control circuitry) determines, for each of a plurality of terminals 600 to be user-multiplexed, a configuration of a reference signal (e.g., Midamble) to be inserted into a data field for the plurality of terminals 600. Radio transceiver 104 (e.g., corresponding to communication circuitry) performs communication processing (e.g., transmission processing) of signals to be user-multiplexed based on the configurations of the reference signals.

For example, in AP 500 illustrated in FIG. 19, a parameter (hereinafter, referred to as a redundancy calculation parameter) for calculating the redundancy in the data field is inputted to Midamble configuration determinater 501. Midamble configuration determiner 501 calculates the redundancy using the redundancy calculation parameter.

The redundancy is, for example, an amount of information to be added other than information bits for each terminal 600. For example, the redundancy is represented by the number of Padding bits.

The redundancy calculation parameter includes, for example, the number of users (the number of terminals 600), a packet length of each user (terminal 600), an RU size, the number of streams, an MCS (Modulation and Coding Scheme), an FEC (Forward Error Correction) coding type, and the like.

Further, the number of Padding bits is calculated according to, for example, Equations (28-60) to (28-63) and (28-76) to (28-88) defined in the 802.11ax standard (see, for example, NPL 3). It should be noted that the method of calculating the number of Padding bits is not limited to the method defined in the 802.11ax standard.

Hereinafter, the number of Padding bits (for example, pre-FEC Padding bits which are Padding bits prior to FEC) is denoted by “N_{PAD,Pre-FEC,u}.”

For example, Midamble configuration determiner 501 calculates the number of Midambles (hereinafter, denoted by “N_{Midamble,PAD,Pre-FEC,u}”) that can be inserted into Padding bits (e.g., pre-FEC Padding bits) portion for data to be transmitted to terminal 600 according to the following equation 1:

$$\begin{matrix} [ 1 ] & \\ {N}_{Midamble , PAD , Pre - FEC , u} = ⌊ \frac{{N}_{PAD , Pre - FEC , u}}{{R}_{u} \cdot {N}_{HE - LTF} \cdot {T}_{HE - LFT - SYM}} ⌋ & ( Equation 1 )\end{matrix}$$

In the above equation 1, Rᵤ represents an encoding rate configured in terminal 600 having the terminal number u, N_{HE-LTF} represents the number of OFDM symbols within an HE-LTF field, and T_{HE-LTF-SYM} represents a length of OFDM symbols including a guard interval within the HE-LTF field. Further, the function on the right side of the equation 1 is a function (for example, a floor function) that returns the largest integer less than or equal to the variable A (here, A=N_{PAD,Pre-FEC,u}/(Rᵤ·N_{HE-LTF}·T_{HE-LTF-SYM})).

Further, Midamble configuration determiner 501 calculates, according to the following equation 2, the number of Padding bits (hereinafter, denoted by “N_{PAD,Pre-FEc,remaming,u}”) excluding the portion of the number of Midambles calculated according to the equation 1:

[2]

N_{PAD,Pre-FEC,remaining,u}=N_{PAD,Pre-FEC,u}−N_{Midamble,PAD,Pre-FEC,u}·Rᵤ·N_{HE-LTF}·T_{HE-LFT-SYM} (Equation 2)

Midamble configuration determiner 501 divides the coded bits after FEC (for example, the number of bits is denoted by “N_{CBPS,last,u}”) by (the number of Midambles calculated according to the equation 1+1) (N_{Midamble,PAD,Pre-FEC,u}+1), and configures a Midamble between symbols divided by the interval (or periodicity) (hereinafter, denoted by “M_{MA,pre-FEC,u}”) represented by the following equation 3.

$$\begin{matrix}[ 3 ] & \\ {M}_{MA , pre - FEC , u} = ⌊ \frac{{N}_{CBPS , last , u}}{{N}_{Midamble , PAD , Pre - FEC , u} + 1} ⌋ & ( Equation 3 )\end{matrix}$$

In the above equation 3, the function on the right side of the equation 3 is a function (for example, a ceil function) that returns the smallest integer larger than or equal to the variable A (here, A=N_{CBPS,last,u}/(N_{Midamble,PAD,Pre-FEC,u}+1)).

In this way, the number of Midambles to be inserted into the data field is determined. Midamble configuration determiner 501 outputs Midamble configuration information indicating the determined Midamble configuration to user specific field generator 110 and user data multiplexer 112.

AP 500 transmits data for the plurality of terminals 600 to be user-multiplexed based on the Midamble configurations determined for respective terminals 600.

On the other hand, in terminal 600 illustrated in FIG. 20, Midamble configuration detector 601 calculates Midamble configuration configured in terminal 600 using the redundancy calculation parameter in the same manner as Midamble configuration determiner 501, and outputs information indicating the calculated Midamble configuration to demodulator 205. In this way, each terminal 600 receives the user-multiplexed data based on the Midamble configuration determined for each terminal 600.

It should be noted that AP 500 may configure the Midamble configuration information indicating the Midamble configuration determined by Midamble configuration determiner 501 in a user specific field within an HE-SIG-B as, for example, in Embodiment 1, and signal the Midamble configuration information to terminal 600. In this case, Midamble configuration detector 601 of terminal 600 detects the Midamble configuration information from, for example, the user specific field within the HE-SIG-B, and outputs the detected Midamble configuration information to demodulator 205.

In addition, AP 500 and terminals 600 may configure a required amount of Midambles for respective terminals 600 within a range in which Midambles can be inserted, for example. For example, as in Embodiment 1, AP 500 and terminals 600 may determine the number of Midambles for respective terminals 600 according to communication environments (e.g., moving speeds) of terminals 600. As a result, the Midamble configuration for each RU suitable for the moving speed of terminal 600 can be determined, so that the reception performance of terminal 600 is improved and the throughput is improved. It should be noted that in the present embodiment, in the case that the Midamble configuration is determined using the redundancy without using the Midamble information, the configurations for generating and signaling the Midamble information in AP 500 illustrated in FIG. 19 and terminal 600 illustrated in FIG. 20 can be omitted.

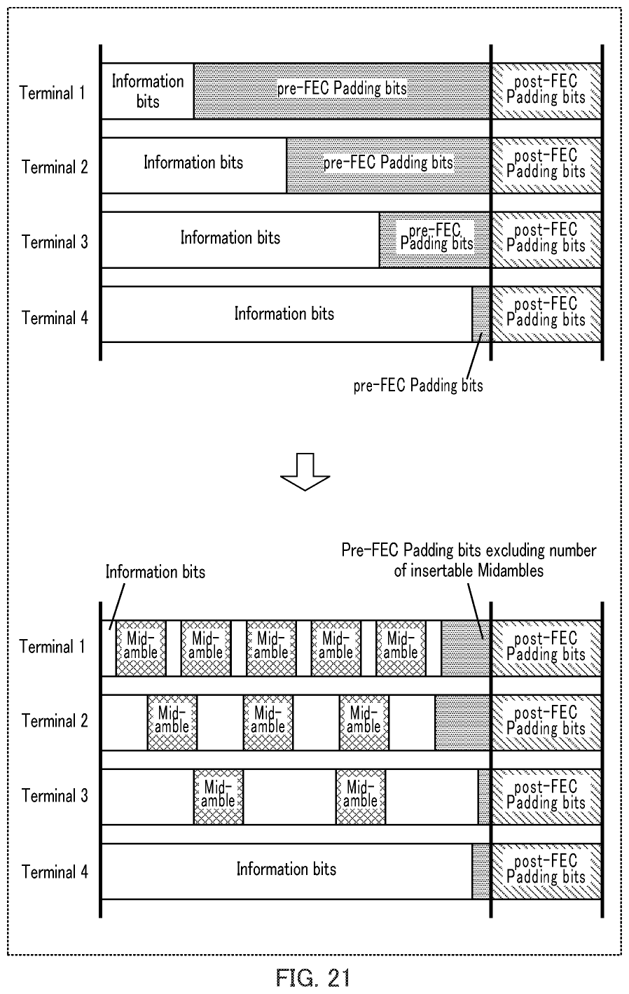

FIG. 21 illustrates examples of Midamble configurations at the time of OFDMA multiplexing according to the present embodiment.

In FIG. 21, as an example, a case will be described in which four terminals 600 (terminals 1 to 4) are user-multiplexed (OFDMA multiplexed). It should be noted that the number of terminals 600 to be user-multiplexed is not limited to 4.

Further, in FIG. 21, the number of information bits is smaller in the order of the terminal 1, the terminal 2, the terminal 3, and the terminal 4. In other words, the redundancy such as the number of Padding bits for user multiplexing (e.g., the number of pre-FEC Padding bits) is larger in the order of the terminal 1, the terminal 2, the terminal 3, and the terminal 4.

In the case of FIG. 21, AP 500 determines a Midamble configuration (e.g., the number of Midambles (N_{Midamble,PAD,Pre-FEC,u}) or a periodicity (M_{MA,pre-FEC,u})) according to the redundancy such as the number of Padding bits for each terminal 600.

As illustrated in FIG. 21, in the Midamble configuration of each terminal 600, the larger the redundancy of terminal 600 is, the more the number of Midambles is. For example, in FIG. 21, five Midambles are configured in the terminal 1, three Midambles are configured in the terminal 2, two Midambles are configured in the terminal 3, and no Midamble is configured in the terminal 4.

In this way, in the present embodiment, in the data field for terminal 600, the redundancy reduces by inserting Midambles instead of Padding bits (in other words, redundant bits). In other words, in the data field for terminal 600, inserting Midambles does not decrease the number of information bits. Therefore, according to the present embodiment, it is possible to prevent the increase in overhead due to Midamble insertion. As a result, in the present embodiment, AP 500 can appropriately configure a Midamble configuration for each terminal 600 according to the redundancy for each terminal 600.

It should be noted that as an example of a method for determining the number of Midambles according to the present embodiment, the redundancy (for example, the number of bits itself corresponding to the redundancy or a group identification number corresponding to the number of bits) and the Midamble configuration (for example, the number of Midambles to be inserted into the data field) may be pre-associated with each other. In this case, AP 500 signals, to terminal 600, information or an identifier (e.g., the number of bits or the group identification number corresponding to the redundancy) regarding the redundancy of each terminal 600. As a result, terminal 600 can determine the number of Midambles based on the information signaled from AP 500.

In addition, in the present embodiment, the number of OFDM symbols can be reduced by reducing the number of Midambles of terminal 600 having the largest number of symbols (in other words, terminal 600 having the smallest redundancy).

Although in the present embodiment, the configuration of the Midamble configuration in the downlink has been described, the present embodiment is similarly applicable to configuration of a Midamble configuration in an uplink.

### Embodiment 3

In the present embodiment, in a Trigger frame, for example, an AID (Association ID) for RA (Random Access) and a Midamble configuration according to a speed condition of a terminal are defined. Thus, the terminal is capable of RA transmission based on the Midamble configuration suitable for the moving speed of the terminal.

A wireless communication system according to the present embodiment includes a AP 700 and terminals 800. For example, AP 700 receives RA signals of the plurality of terminals 800 that are OFDMA multiplexed.

[Configuration of AP]

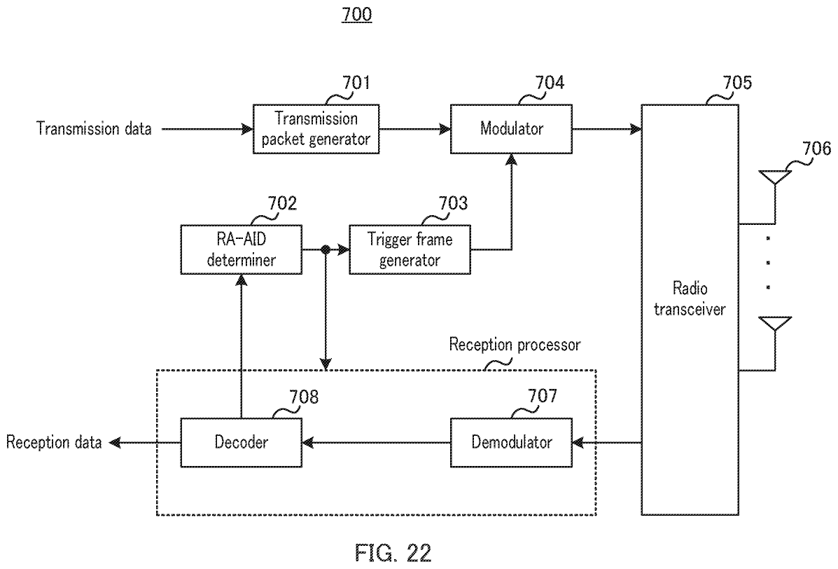

FIG. 22 is a block diagram illustrating an exemplary configuration of AP 700 according to the present embodiment.

In FIG. 22, AP 700 includes transmission packet generator 701, RA-AID determiner 702, Trigger frame generator 703, modulator 704, radio transceiver 705, antenna 706, and a reception processor (for example, demodulator 707 and decoder 708).

In AP 700 illustrated in FIG. 22, RA-AID determiner 702 (e.g., corresponding to control circuitry) determines, for each of the plurality of terminals 800 to be user-multiplied, a configuration (in other words, an RA-AID corresponding to a Midamble configuration) of reference signals (e.g., Midambles) to be inserted into a data field for the pulurality of terminals 800. Radio transceiver 705 (e.g., corresponding to communication circuitry) performs communication processing (e.g., reception processing) of signals user-multiplexed based on the configurations of the reference signals.

For example, transmission packet generator 701 generates a transmission packet comprising a preamble and data. Transmission packet generator 701 outputs the generated transmission packet to modulator 704.

RA-AID determiner 702 determines an RA-AID to be configured for each terminal 800.

The RA-AID is a signal to indicate, to terminal 800, a resource unit (RU) to be used for RA transmission. In the present embodiment, an RA-AID is associated with an RA-RU (RU for RA) transmission as well as a Midamble configuration configured in the RU. Further, for example, a Midamble configuration is configured according to a moving speed of a terminal in the same manner as in Embodiment 1. In other words, an RA-AID is associated with a speed condition of a terminal (for example, any of a low speed, a medium speed, and a high speed). For example, an unused AID in “Scheduled access” which is a method for allocating an RU by signaling of an AID assigned to a terminal may be configured in the RA-AID according to the speed condition of the terminal.

RA-AID determiner 702 determines the RA-AID (in other words, Midamble configuration) according to the moving speed of each terminal 800 based on Midamble information (e.g., moving speed information) transmitted from each terminal 800 which is outputted from decoder 708, for example. RA-AID determiner 702 outputs the determined the AIDs for RA of respective terminals 800 to Trigger frame generator 703.

Trigger frame generator 703 generates a Trigger frame including the AIDs for RA outputted from RA-AID determiner 702. Trigger frame generator 703 outputs the generated Trigger frame to modulator 704.

Modulator 704 performs modulation processing on the transmission packet outputted from transmission packet generator 701 or the Trigger frame outputted from Trigger frame generator 703. Modulator 704 outputs the modulated signal to radio transceiver 705.

Radio transceiver 705 performs radio transmission processing on the signal outputted from modulator 704, and transmits the signal after the radio transmission processing to terminal 800 via antenna 706. Further, radio transceiver 705 receives a signal (e.g., Midamble information or an RA signal) transmitted from terminal 800 via antenna 706, performs radio reception processing on the received signal, and outputs the signal after the radio reception processing to demodulator 707 of the reception processor. In this way, AP 700 implicitly signals the Midamble configuration associated with the RA-AID to terminal 800 by signaling the RA-AID to terminal 800.

Demodulator 707 performs demodulation processing on the received signal outputted from radio transceiver 705. Demodulator 707 outputs the demodulated signal to decoder 708.

Decoder 708 performs decoding processing on the signal (e.g., including a preamble or data transmitted from terminal 800) outputted from demodulator 707. For example, decoder 708 outputs the Midamble information included in the decoded signal to RA-AID determiner 702, and outputs the decoded data (reception data) included in the decoded signal.

It should be noted that demodulator 707 and decoder 708 perform reception processing (e.g., demodulation processing and decoding processing) in accordance with the RUs and Midamble configurations associated with the AIDs for RA signaled to respective terminals 800.

[Configuration of Terminal]

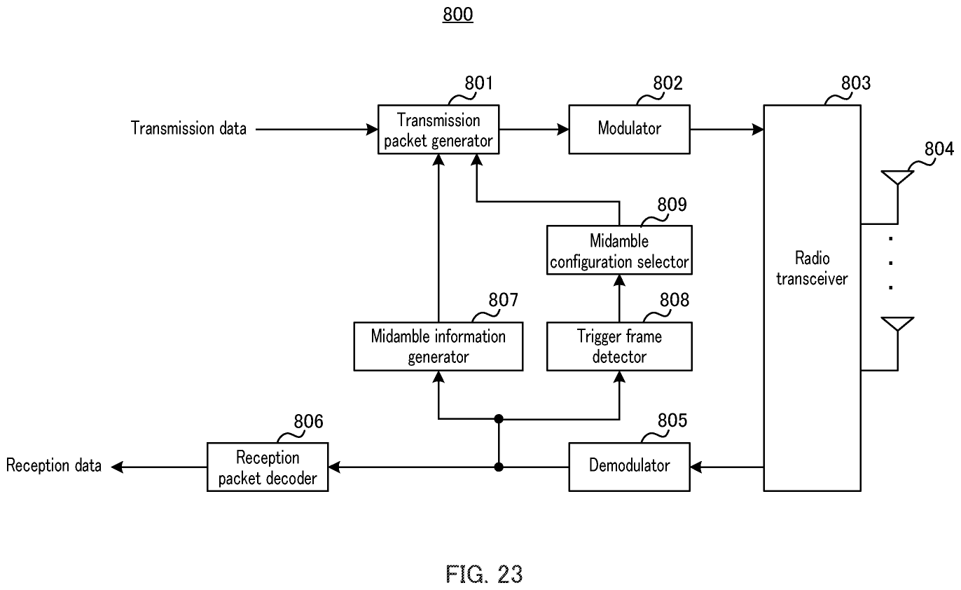

FIG. 23 is a block diagram illustrating an exemplary configuration of terminal 800 according to the present embodiment.

In FIG. 23, terminal 800 includes transmission packet generator 801, modulator 802, radio transceiver 803, antenna 804, demodulator 805, reception packet decoder 806, Midamble information generator 807, Trigger frame detector 808, and Midamble configuration selector 809.

Transmission packet generator 801 generates a transmission packet (e.g., an RA signal) comprising a preamble and data. The transmission packet includes, for example, Midamble information outputted from Midamble information generator 807. Further, transmission packet generator 801 determines arrangement of transmission data (e.g., including a Midamble) based on Midamble configuration information and RU information outputted from Midamble configuration selector 809. Transmission packet generator 801 outputs the generated transmission packet to modulator 802.

Modulator 802 performs modulation processing on the transmission packet outputted from transmission packet generator 801, and outputs the modulated signal to radio transceiver 803.

Radio transceiver 803 performs radio transmission processing on the signal (e.g., Midamble information or RA signal) outputted from modulator 802, and transmits the signal after the radio transmission processing to AP 700 via antenna 804. Further, radio transceiver 803 receives a signal (e.g., a Trigger frame) transmitted from AP 700 via antenna 804, performs radio reception processing on the received signal, and outputs the signal after the radio reception processing to demodulator 805.

Demodulator 805 performs demodulation processing on the signal outputted from radio transceiver 803. Demodulation 805 outputs the demodulated signal to reception packet decoder 806, Trigger frame detector 808, and Midamble information generator 807.

Reception packet decoder 806 decodes, from the demodulated signal outputted from demodulator 805, a preamble or data transmitted from AP 700. Reception packet decoder 806 outputs the decoded signal (reception data).

Midamble information generator 807 generates Midamble information. Midamble information generator 807 measures a relative speed between terminal 800 and AP 700 based on, for example, a level fluctuation rate of the demodulated signal outputted from demodulator 805. Midamble information generator 807 outputs the Midamble information including moving speed information indicating the measured moving speed to transmission packet generator 801. It should be noted that in Midamble information generator 807, the moving speed of terminal 800 is not limited to the case in which it is determined from the level fluctuation rate of the demodulated signal. For example, when terminal 800 is mounted on an vehicle (not illustrated), Midamble information generator 807 may obtain vehicle speed information from another means such as a vehicle speed sensor, and measure the moving speed of terminal 800 based on the vehicle speed information.

Trigger frame detector 808 detects a Trigger frame from the demodulated signal outputted from demodulator 805. Trigger frame detector 808 outputs an RA-AID configured with respect to terminal 800 included in the detected Trigger frame to Midamble configuration selector 809.

Midamble configuration selector 809 randomly selects an RU to be used for RA transmission from among at least one RU associated with the RA-AID outputted from Trigger frame detector 808. Midamble configuration selector 809 also selects a Midamble configuration associated with the RA-AID outputted from Trigger frame detector 808. Midamble configuration selector 809 outputs Midamble configuration information indicating the selected Midamble configuration and RU information indicating the selected RU to transmission packet generator 801.

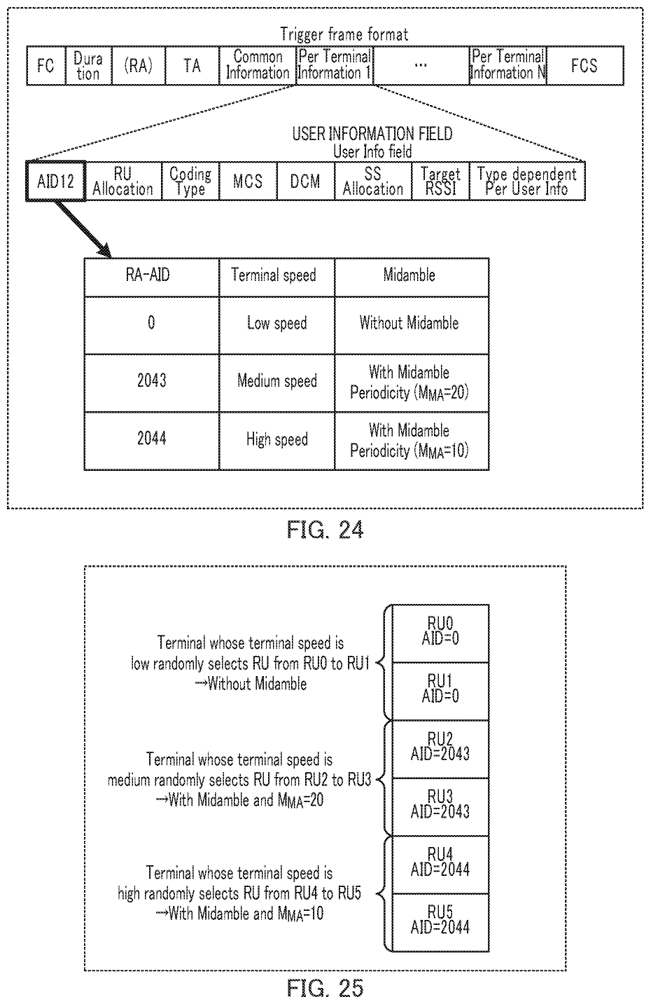

FIG. 24 illustrates an exemplary configuration of a Trigger frame signaled from AP 700 to terminal 800.

As illustrated in FIG. 24, an RA-AID is configured in, for example, an “AID12” subfield within a per terminal information field (user information field) of the Trigger frame. For example, in the AID12 subfield of the per terminal information field of FIG. 24, an AID assigned to terminal 800 at the time of association is signaled. Further, in the AID12 subfield of the per terminal information field of FIG. 24, the RA-AID is signaled. The RA-AID is, for example, an unsed AID for the AID assigned to terminal 800 at the time of association.

In the present embodiment, for example, as illustrated in FIG. 24, AIDs for RA, terminal speeds (e.g., a low speed, a medium speed, and a high speed), and Midamble configurations are associated with each other.

In FIG. 24, for example, AIDs that are not used in Scheduled access (e.g., AID=0, AID=2043, and AID=2044) are used as the AIDs for RA according to the speed condition of terminal 800. For example, when the AID signaled in the Trigger frame is any of 0, 2043, and 2044, terminal 800 can identify that an RU indicated in an RU Allocation subfield is an RA-RU.

It should be noted that as the AIDs for RA, not only the unused AIDs in Scheduled access, but also other AIDs may be used. Further, although in FIG. 24, the case of the Associated STA (in other words, the case in which an AID unused in Scheduled access is defined as an RA-AID) is exemplified, an RA-AID may be separately defined for a Non associated STA.

In FIG. 24, as an example, different Midamble configurations (e.g., the presence or absence, and a periodicity) are defined corresponding to “RA-AID=0,” “RA-AID=2043,” and “RA-AID=2044,” respectively. For example, a low speed terminal and a Midamble configuration which has no Midambles are associated with “RA-AID=0.” Further, a medium speed of a terminal and a Midamble configuration which has Midambles and its periodicity M_{MA}=20 are associated with “RA-AID=2043.” In addition, a high-speed of a terminal and a Midamble configuration which has Midambles and its periodicity M_{MA}=10 are associated with “RA-AID=2044.”

For example, AP 700 determines an RA-AID corresponding to a moving speed of terminal 800. In this way, for terminal 800, a Midamble configuration corresponding to the moving speed of terminal 800 is determined.

FIG. 25 illustrates an example of a correspondence between an RU and a Midamble configuration.

In FIG. 25, an RU0 and an RU1 are associated with “RA-AID=0” (for a low speed terminal), an RU2 and an RU3 are associated with “RA-AID=2043” (for a medium speed terminal), and an RU4 and an RU5 are associated with “RA-AID=2044” (for a high speed terminal).

Terminal 800 identifies RUs and a Midamble configuration corresponding to the RA-AID included in the Trigger frame transmitted from AP 700.

For example, when a moving speed of terminal 800 is low, terminal 800 randomly selects am RU from among the RU0 and the RU1 illustrated in FIG. 25. Terminal 800 does not insert a Midamble in RA transmission.

Further, for example, when a moving speed of terminal 800 is medium, terminal 800 randomly selects an RU from among the RU2 and the RU3 illustrated in FIG. 25. Terminal 800 inserts a Midamble with a periodicity M_{MA}=20 in RA transmission.

In addition, for example, when a moving speed of terminal 800 is high, terminal 800 randomly selects an RU from among the RU4 and the RU5 illustrated in FIG. 25. Terminal 800 inserts a Midamble with a periodicity M_{MA}=10 in RA transmission.

In this way, in the present embodiment, the RA-AID indicating the RA-RUs (e.g., corresponding to an identifier indicating a resource for random access) and the Midamble configuration (e.g., corresponding to a configuration of a reference signal to be inserted into a data field) are pre-associated with each other. The RA-RUs (e.g., corresponding to an identifier indicating a resource for a random access) are also associated with a condition (e.g., the terminal speed in FIG. 24) regarding the moving speed of terminal 800. As a result, terminal 800 is capable of RA transmission with the Midamble configuration according to the moving speed of terminal 800 based on signaling of the RA-AID, so that the throughput is improved. Further, in the present embodiment, since the AIDs for RA and the Midamble configurations are predefined, except for signaling of the RA-AID from AP 700 to terminal 800, a new signaling for communicating the Midamble configuration information is not necessary.

It should be noted that in the present embodiment, the case in which AP 700 determines the RA-AID according to the moving speed of terminal 800 has been described. However, in the present embodiment, terminal 800 may select an RA-AID corresponding to a moving speed of terminal 800, for example, from among AIDs for RA (e.g., any of 0, 2043, and 2044 in FIG. 24), and select an RU and a Midamble configuration associated with the selected value. In this case, terminal 800 may not communicate moving speed information of terminal 800 to AP 700. For example, AP 700 may calculate a relative speed level between AP 700 and terminal 800 based on a measurement result of an uplink signal level transmitted from terminal 800, and determine an RA-AID for terminal 800 based on the calculated relative speed level.

### Embodiment 4

In the present embodiment, a Midamble configuration is predefined for each of a plurality of frequency bands.

For example, a Midamble configuration is predefined for each RU or band assuming multi-user multiplexing or multi-band MU multiplexing.

For example, an RU for a terminal moving at a high speed, an RU for a terminal moving at a medium speed, and an RU for a terminal moving at a low speed may be configured in advance. For example, a Midamble configuration according to an assumed terminal speed is defined for each RU. In this case, according to a moving speed of a terminal, an AP determines an RU to which a transmission packet corresponding to the terminal is allocated (or accommodated) and a Midamble configuration.

Alternatively, a band for a terminal moving at a high speed, a band for a terminal moving at a medium speed, and a band for a terminal moving at a low speed may be configured in advance. For example, a Midamble configuration according to an assumed terminal speed is defined for each band. In this case, according to a moving speed of a terminal, an AP determines a band to which a transmission packet corresponding to the terminal is allocated (or accommodated) and a Midamble configuration.

In this way, in the present embodiment, as in Embodiment 1, an unnecessary Midamble can be reduced, and the throughput can be improved. Further, in the present embodiment, since the Midamble configurations are predefined, a new signaling for communicating a Midamble configuration is not necessary.

It should be noted that the AP and the terminal according to the present embodiment may have any of the configurations of Embodiments 1 to 3 (FIGS. 7, 8, 14, 15, 19, 20, 22, and 23), for example.

Hereinafter, examples in which a Midamble configuration is defined for each RU or band according to the present embodiment will be described.

### Example 1

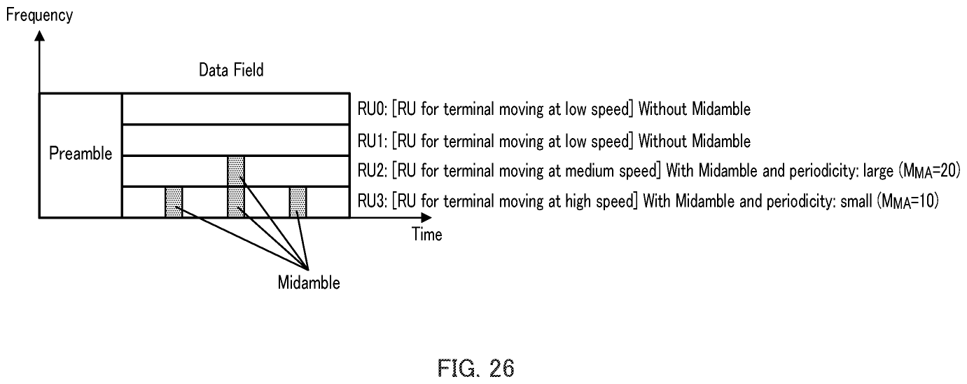

FIG. 26 illustrates an example in which a Midamble configuration is defined for each RU.

RU0 and RU1 illustrated in FIG. 26 are RUs for a terminal moving at a low speed, and a Midamble configuration (e.g., without a Midamble) for the terminal moving at the low speed is defined in the RU0 and the RU1. Further, an RU2 illustrated in FIG. 26 is an RU for a terminal moving at a medium speed, and a Midamble configuration (e.g., with a Midamble and a periodicity: large (M_{MA}=20)) for the terminal moving at the medium speed is defined in the RU2. Furthermore, an RU3 illustrated in FIG. 26 is an RU for a terminal moving at a high speed, and a Midamble configuration (e.g., with a Midamble and a periodicity: small (M_{MA}=10)) for the terminal moving at the high speed is defined in the RU3.

For example, according to on a moving speed of a terminal, an RU in which the terminal is accommodated and a Midamble configuration configured in the terminal are determined.

### Example 2

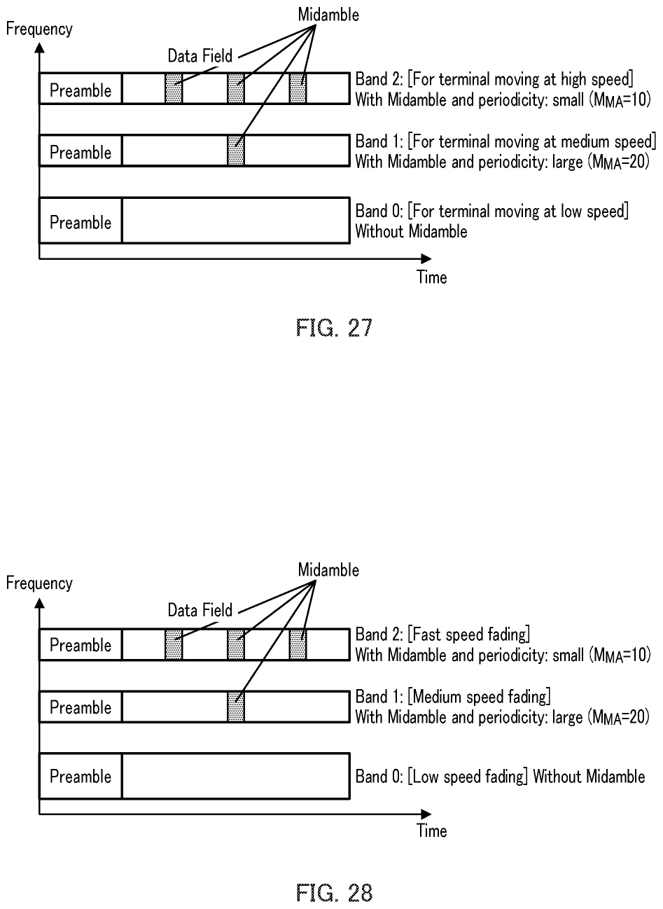

FIG. 27 illustrates an example in which a Midamble configuration is defined for each band.

A band 0 illustrated in FIG. 27 is a band for a terminal moving at a low speed, and a Midamble configuration (e.g., without a Midamble) for the terminal moving at the low speed low speed is defined in the band 0. Further, a band 1 illustrated in FIG. 27 is a band for a terminal moving at a medium speed, and a Midamble configuration (e.g., with a Midamble and a periodicity: large (M_{MA}=20)) for the terminal moving at the medium speed is defined in the band 1. Furthermore, a band 2 illustrated in FIG. 27 is a band for a terminal moving at a high speed, and a Midamble configuration (e.g., with a Midamble and a periodicity: small (M_{M}A=10)) for the terminal moving at the high is defined in the band 2.

For example, according to a moving speed of a terminal, a band in which the terminal is accommodated and a Midamble configuration configured in the terminal are determined.

### Example 3

A fading environment differs depending on a frequency band in which each band is arranged. Then, in Example 3, a Midamble configuration is defined depending on a fading environment of a frequency band in which each band is arranged.

FIG. 28 illustrates another example in which a Midamble configuration is defined for each band.

In a band 0 illustrated in FIG. 28, there is a low speed fading environment, and a Midamble configuration (e.g., without a Midamble) for the low speed fading is defined in the band 0. Further, in a band 1 arranged in a higher frequency band than the band 0 illustrated in FIG. 28, there is a medium speed fading environment, and a Midamble configuration (e.g., with a Midamble and a periodicity: large (M_{MA}=20)) for the medium speed fading is defined in the band 1. Furthermore, in a band 2 arranged in a higher frequency band than the band 1 illustrated in FIG. 28, there is a fast speed fading environment, and a Midamble configuration (e.g., with a Midamble and a periodicity: small (M_{MA}=10)) for the fast speed fading is defined in the band 2.

For example, according to a band in which a terminal is accommodated, a Midamble configuration suitable for a fading environment of the band is determined.

### Example 4

In Example 4, a plurality of Midamble configurations are defined in at least one band (or RU).

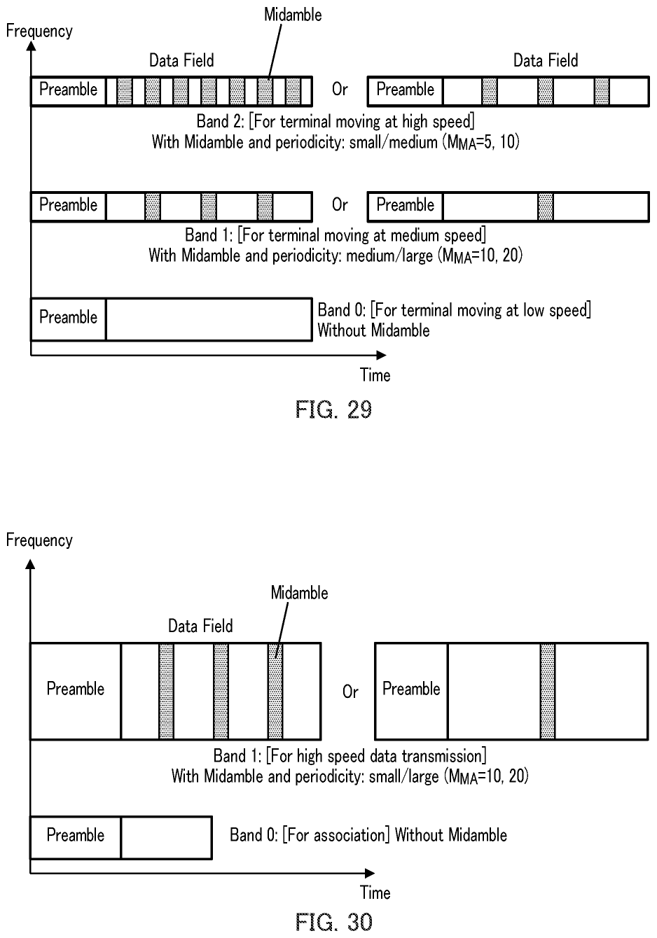

FIG. 29 illustrates another example in which one or more Midamble configurations are defined for each band.

A band 0 illustrated in FIG. 29 is a band for a terminal moving at a low speed, and a Midamble configuration (e.g., without a Midamble) for the terminal moving at the low speed is defined in the band 0.

Further, a band 1 illustrated in FIG. 29 is a band for a terminal moving at a medium speed, and as Midamble configurations for the terminal moving at the medium speed, for example, a Midamble and a periodicity: medium (M_{MA}=10) and a Midamble and a periodicity: large (M_{MA}=20) are defined in the band 1.

Furthermore, a band 2 illustrated in FIG. 29 is a band for a terminal moving at a high speed, and as Midamble configurations for the terminal moving at the high speed, for example, a Midamble and a periodicity: small (M_{MA}=5) and a Midamble and a periodicity: medium (M_{MA}=10) are defined in the band 2.

For example, according to a band in which a terminal is accommodated, a Midamble configuration suitable for a fading environment of the band is determined. Further, in the band 1 and the band 2 illustrated in FIG. 29, for example, as in Embodiment 1, one Midamble configuration (periodicity) is selected from among the plurality of Midamble configuration candidates according to a moving speed of the terminal.

It should be noted that FIG. 29 is an example, and the number of Midamble configuration candidates defined in the band 1 and the band 2 is not limited to 2, and the number of Midamble configuration candidates defined in the band 0 is not limited to 1. For example, Midamble configuration (e.g., periodicity) candidates configured in different bands (the band 1 and the band 2 in FIG. 29) may be partially overlapping, or all candidates may be different.

### Example 5

FIG. 30 illustrates another example in which a Midamble configuration is defined for each band.

A band 0 illustrated in FIG. 30 is a band for association for connecting an AP and a terminal, and for example, no Midamble is defined in the band 0.

Further, a band 1 illustrated in FIG. 30 is a band for high speed data transmission, and, for example, a Midamble, and a plurality of Midamble periodicities (e.g., a periodicity: large (M_{MA}=20) and a periodicity: small (M_{MA}=10)) are defined in the band 1.

For example, according to an operation (e.g., association or high speed transmission) of a terminal, a band and a Midamble configuration are determined. Further, in the band 1 illustrated in FIG. 30, for example, as in Embodiment 1, one Midamble configuration (periodicity) is selected from among the plurality of Midamble configuration candidates according to a moving speed of the terminal.

It should be noted that although FIG. 30 illustrates the example in which the plurality of Midamble periodicity candidates are defined in the band 1, the present embodiment is not limited thereto. For example, a plurality of Midamble periodicities may be fixedly defined for each of different bands.

Further, the Midamble configuration(s) defined for each RU or band described above may be predefined in standardized specifications, and/or may be signaled to each terminal as broadcast information.

Furthermore, the definitions of the Midamble configurations in the RUs or bands (e.g., FIGS. 26 to 30) described in the present embodiment are examples, and the correspondence between the RU or band and the Midamble configuration(s), the Midamble configuration (the presence or absence or periodicity, etc.), the number of defined Midamble configuration candidates, or the like is not limited to these examples.

The embodiments of the present disclosure have been described above.

### OTHER EMBODIMENTS

It should be noted that although in the above embodiments, the use of HE (High Efficiency) assuming 802.11ax has been described as an example, the embodiments are not limited to 802.11ax. For example, an embodiment of the present disclosure may be applied to EHT (Extremely High Throughput) which is a next generation standard of 802.11ax or NGV which is a next generation standard of an 802.11p which is a standard for in-vehicle equipment.

Further, although in the above embodiments, the case has been described in which the Midamble configuration includes, for example, the presence or absence of a Midamble and a Midamble periodicity (e.g., M_{MA}), the parameters representing the Midamble configuration are not limited to thereto. For example, the Midamble configuration may include an HE-LTF mode within each Midamble and/or may include other parameters regarding the Midamble configuration.

Furthermore, although in the above embodiments, the case has been described as an example in which “no Midamble (without a Midamble)” is configured with respect to a terminal moving at a low speed, the Midamble configuration for the terminal moving at the low speed is not limited thereto. For example, in the Midamble configuration for the terminal moving at the low speed, a “Midamble” may be configured, a longer periodicity may be configured and/or an HE-LTF mode in which the HE-LTF overhead is smaller may be configured as compared to a Midamble configuration configured in a terminal moving at a high speed (or a medium speed).

In addition, although in the above embodiments, the case has been described in which the moving speed of the terminal is classified into the two groups of low speed and high speed, or the three groups of low speed, medium speed, and high speed, the grouping of the moving speed of the terminal is not limited to the two or three groups.

The present disclosure can be realized by software, hardware, or software in cooperation with hardware.

Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

Technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A communication apparatus according to an embodiment of the present disclosure, includes: control circuitry which, in operation, determines, for each of a plurality of terminals to be user-multiplexed, a configuration of reference signals to be inserted into a data field for the plurality of terminals; and communication circuitry which, in operation, performs communication processing of signals to be user-multiplexed based on the configurations of the reference signals.

In the communication apparatus according to an embodiment of the present disclosure, the control circuitry determines the configuration of the reference signal according to a communication environment of each of the plurality of terminals.

In the communication apparatus according to an embodiment of the present disclosure, the communication environment corresponds to a moving speed of the terminal, and in the configuration of the reference signal, the faster the moving speed is, the more the number of reference signals is.

In the communication apparatus according to an embodiment of the present disclosure, the control circuitry determines the configuration of the reference signal according to a redundancy in the data field for each of the plurality of terminals.

In the communication apparatus according to an embodiment of the present disclosure, in the configuration of the reference signal, the larger the redundancy is, the more the number of reference signals is.

In the communication apparatus according to an embodiment of the present disclosure, the redundancy and the configuration of the reference signal are pre-associated with each other.

In the communication apparatus according to an embodiment of the present disclosure, an identifier indicating a resource for random access and the configuration of the reference signal are associated with each other.

In the communication apparatus according to an embodiment of the present disclosure, the identifier is associated with a condition regarding a moving speed of the terminal.

In the communication apparatus according to an embodiment of the present disclosure, the configuration of the reference signal is defined for each of a plurality of frequency bands.

A communication method according to an embodiment of the present disclosure, includes: determining, for each of a plurality of terminals to be user-multiplexed, a configuration of a reference signal to be inserted into a data field for the plurality of terminals; and performing communication processing of signals to be user-multiplexed based on the configurations of the reference signals.

The disclosure of Japanese Patent Application No. 2018-202052, filed on Oct. 26, 2018, including the specification, drawings, and abstract is incorporated herein by reference in its entirety.

### INDUSTRIAL APPLICABILITY

One embodiment of the present disclosure is useful for a communication system.

### REFERENCE SIGNS LIST

100, 400, 500, 700 AP
101 Trigger generator
102, 402, 703 Trigger frame generator
103, 202, 302, 403, 704, 802 Modulator
104, 203, 303, 404, 705, 803 Radio transceiver
105, 204, 304, 405, 706, 804 Antenna
106, 205, 305, 406, 707, 805 Demodulator
107, 407, 708 Decoder
108, 408 Reception quality measurer
109, 409, 501 Midamble configuration determiner
110 User specific field generator
111 Preamble generator
112 User data multiplexer
200, 300, 600, 800 Terminal
201, 301, 401, 701, 801 Transmission packet generator
206, 307, 601 Midamble configuration detector
207, 306, 806 Reception packet decoder
208 Trigger frame decoder
209, 308, 807 Midamble information generator
702 RA-AID determiner
808 Trigger frame detector
809 Midamble configuration selector

1. A communication apparatus comprising:
control circuitry which, in operation, determines, for each of a plurality of terminals to be user-multiplexed, a configuration of a reference signal to be inserted into a data field for the plurality of terminals; and
communication circuitry which, in operation, performs communication processing of signals to be user-multiplexed based on the configurations of the reference signals.

2. The communication apparatus according to claim 1, wherein the control circuitry determines the configuration of the reference signal according to a communication environment of each of the plurality of terminals.

3. The communication apparatus according to claim 2, wherein:
the communication environment corresponds to a moving speed of the terminal, and
in the configuration of the reference signal, the faster the moving speed is, the more the number of reference signals is.

4. The communication apparatus according to claim 1, wherein the control circuitry determines the configuration of the reference signal according to a redundancy in the data field for each of the plurality of terminals.

5. The communication apparatus according to claim 4, wherein in the configuration of the reference signal, the larger the redundancy is, the more the number of reference signals is.

6. The communication apparatus according to claim 4, wherein the redundancy and the configuration of the reference signal are pre-associated with each other.

7. The communication apparatus according to claim 1, wherein an identifier indicating a resource for random access and the configuration of the reference signal are associated with each other.

8. The communication apparatus according to claim 7, wherein the identifier is associated with a condition regarding a moving speed of the terminal.

9. The communication apparatus according to claim 1, wherein the configuration of the reference signal is defined for each of a plurality of frequency bands.

10. A communication method comprising:
determining, for each of a plurality of terminals to be user-multiplexed, a configuration of a reference signal to be inserted into a data field for the plurality of terminals; and
performing communication processing of signals to be user-multiplexed based on the configurations of the reference signals.
